(19) United States
(12) Patent Application Publication
(10) Pub. No.: US 2024/0361245 A1
(43) Pub. Date: Oct. 31, 2024

(54) INFORMATION PROCESSING APPARATUS, MICROSCOPE SYSTEM, AND INFORMATION PROCESSING METHOD

(71) Applicant: Sony Group Corporation, Tokyo (JP)

(72) Inventors: Sakiko Yasukawa, Tokyo (JP); Noriyuki Kishii, Kanagawa (JP); Kazuhiro Nakagawa, Saitama (JP)

(73) Assignee: Sony Group Corporation, Tokyo (JP)

(21) Appl. No.: 18/571,834

(22) PCT Filed: Feb. 21, 2022
(86) PCT No.: PCT/JP2022/006842

§ 371 Date: Dec. 19, 2023

(30) Foreign Application Priority Data
Jun. 29, 2021 (JP) 2021-107889

(51) Int. Cl. G01N 21/64

(52) U.S. Cl. CPC G01N 21/6458; G01N 2201/1217; G01N 2201/1247

(57) ABSTRACT

Provided is an advantageous technique for determining a positive threshold value for use in analyzing a stained specimen fluorescence spectrum.

An information processing apparatus includes a threshold value determination unit configured to determine a positive threshold value that is to be compared with image data of a plurality of image sections included in a stained fluorescence component image, in which the positive threshold value is a criterion for determining whether or not each of the plurality of image sections corresponds to a positive cell image. The threshold value determination unit determines the positive threshold value on the basis of an unstained fluorescence component image.

### TECHNICAL FIELD

The present disclosure relates to an information processing apparatus, a microscope system, and an information processing method.

### BACKGROUND ART

In recent years, fluorescence and multiple labeling of immunostaining have been widely used by virtue of development of cancer immunotherapy and the like. For example, a measurement technique is known in which an autofluorescence spectrum is extracted from an unstained slice of the same tissue block, and fluorescence separation of a stained slice is performed using the autofluorescence spectrum.

Furthermore, a method for detecting positive cells in a stained slice on the basis of image analysis of the stained slice has also been proposed. Patent Document 1 discloses a detection method for positive cells in a stained tissue specimen. According to the detection method of Patent Document 1, a region that is dyed at a detection threshold value or higher is detected for a standardized image of a dyed tissue specimen, and the number of positive cell images selected from the detected region and coordinates of a center of gravity are recorded.

### CITATION LIST

### Patent Document

Patent Document 1: Japanese Patent Application Laid-Open No. 2008-216077

### SUMMARY OF THE INVENTION

### Problems to be Solved by the Invention

In a cell quantity measurement technique using flow cytometry for measuring light intensity values of individual cells, an influence of autofluorescence originating from tissue cells is small. Furthermore, in flow cytometry, as long as sufficient light intensity can be detected, it is relatively easy to set a positive threshold value for detecting a target sample as positive by using a histogram of intensity values (background values) detected in a control sample such as unlabeled cells.

Whereas, in a case where image analysis such as cell quantity measurement is performed on the basis of an image of a tissue specimen without using flow cytometry, background values, such as physical signals due to non-specific adsorption of reagents, noise originating from hardware, and autofluorescence signals originating from tissue components and encapsulants, are high. Furthermore, in image analysis of a tissue specimen, in a case of estimating a positive threshold value by using a background value of a negative control sample used in flow cytometry, the analysis becomes unstable, which disables appropriate estimation of the positive threshold value in some cases.

Furthermore, in flow cytometry, measurement is performed by dividing a population of cells into a “stained cell group” and a “negative control group”. Whereas, in a case where a stained specimen and a negative control specimen are consecutive slices, the stained specimen and the negative control specimen are cell populations that are similar in histological features but different from each other.

As described above, in the measurement technique using image analysis of a tissue specimen, it is difficult to appropriately determine the positive threshold value as compared with the measurement technique using flow cytometry, and a degree of difficulty of automation is high. Therefore, in practice, the positive threshold value may be determined or adjusted on the basis of subjectivity of the user, but in that case, it is difficult to stably perform highly accurate measurement between different users.

The detection method disclosed in Patent Document 1 described above uses only an image of a stained slice as input data for analysis, and detects a detection cell image while gradually changing a detection threshold value. Therefore, in the detection method of Patent Document 1, for example, in a case where the cell quantity is extremely small or large, or in a case where background noise is large, sufficient detection accuracy cannot be guaranteed.

The present disclosure provides an advantageous technique for determining a positive threshold value for use in analyzing a stained specimen fluorescence spectrum.

### Solutions to Problems

One aspect of the present disclosure relates to an information processing apparatus including: a first separation unit configured to separate a stained specimen fluorescence spectrum into a stained fluorescence component image containing a fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent; a second separation unit configured to separate an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent; a threshold value determination unit configured to determine a positive threshold value that is to be compared with image data of a plurality of image sections included in the stained fluorescence component image on the basis of the stained fluorescence component image, the positive threshold value being a criterion for determining whether or not each of the plurality of image sections corresponds to a positive cell image; and a threshold value output unit configured to output the positive threshold value.

The first separation unit may: generate a pseudo stained fluorescence spectrum on the basis of the stained fluorescence component image and the fluorescence reference spectrum; generate a pseudo stained autofluorescence spectrum on the basis of the stained autofluorescence component image and the autofluorescence reference spectrum; generate a pseudo stained specimen fluorescence spectrum on the basis of the pseudo stained fluorescence spectrum and the pseudo stained autofluorescence spectrum; generate a difference stained specimen fluorescence spectrum on the basis of a difference between the stained specimen fluorescence spectrum and the pseudo stained specimen fluorescence spectrum; and separate the difference stained specimen fluorescence spectrum into a difference stained fluorescence component image containing the fluorescent reagent and a difference stained autofluorescence component image containing the autofluorescence component by using the fluorescence reference spectrum and the autofluorescence reference spectrum, and the second separation unit may: generate a pseudo unstained fluorescence spectrum on the basis of the unstained fluorescence component image and the fluorescence reference spectrum; generate a pseudo unstained autofluorescence spectrum on the basis of the unstained autofluorescence component image and the autofluorescence reference spectrum; generate a pseudo unstained specimen fluorescence spectrum on the basis of the pseudo unstained fluorescence spectrum and the pseudo unstained autofluorescence spectrum; generate a difference unstained specimen fluorescence spectrum on the basis of a difference between the unstained specimen fluorescence spectrum and the pseudo unstained specimen fluorescence spectrum; and separate the difference unstained specimen fluorescence spectrum into a difference unstained fluorescence component image containing the fluorescent reagent and a difference unstained autofluorescence component image containing the autofluorescence component by using the fluorescence reference spectrum and the autofluorescence reference spectrum, and the threshold value determination unit may correct the positive threshold value on the basis of a spectrum of the difference stained fluorescence component image and a spectrum of the difference unstained fluorescence component image.

The first separation unit may: generate a pseudo stained fluorescence spectrum on the basis of the stained fluorescence component image and the fluorescence reference spectrum; generate a pseudo stained autofluorescence spectrum on the basis of the stained autofluorescence component image and the autofluorescence reference spectrum; generate a pseudo stained specimen fluorescence spectrum on the basis of the pseudo stained fluorescence spectrum and the pseudo stained autofluorescence spectrum; and generate a difference stained specimen fluorescence spectrum on the basis of a difference between the stained specimen fluorescence spectrum and the pseudo stained specimen fluorescence spectrum, the second separation unit may: generate a pseudo unstained fluorescence spectrum on the basis of the unstained fluorescence component image and the fluorescence reference spectrum; generate a pseudo unstained autofluorescence spectrum on the basis of the unstained autofluorescence component image and the autofluorescence reference spectrum; generate a pseudo unstained specimen fluorescence spectrum on the basis of the pseudo unstained fluorescence spectrum and the pseudo unstained autofluorescence spectrum; and generate a difference unstained specimen fluorescence spectrum on the basis of a difference between the unstained specimen fluorescence spectrum and the pseudo unstained specimen fluorescence spectrum, and the threshold value determination unit may correct the positive threshold value on the basis of the difference stained specimen fluorescence spectrum and the difference unstained specimen fluorescence spectrum.

The second separation unit may: generate a pseudo unstained fluorescence spectrum on the basis of the unstained fluorescence component image and the fluorescence reference spectrum; generate a pseudo unstained autofluorescence spectrum on the basis of the unstained autofluorescence component image and the autofluorescence reference spectrum; generate a pseudo unstained specimen fluorescence spectrum on the basis of the pseudo unstained fluorescence spectrum and the pseudo unstained autofluorescence spectrum; generate a difference unstained specimen fluorescence spectrum on the basis of a difference between the unstained specimen fluorescence spectrum and the pseudo unstained specimen fluorescence spectrum; and generate difference unstained norm data that is norm data of the difference unstained specimen fluorescence spectrum, and the threshold value determination unit may: analyze the difference unstained norm data to acquire outlier data; correct the unstained fluorescence component image on the basis of the outlier data; and determine the positive threshold value on the basis of the corrected unstained fluorescence component image.

The threshold value determination unit may correct the positive threshold value on the basis of a correction value determined in advance in accordance with the fluorescent reagent.

On the basis of reagent identification information associated with the fluorescent reagent, the threshold value determination unit may acquire the correction value from a correction data storage unit that stores the reagent identification information and the correction value in association with each other.

The threshold value determination unit may correct the positive threshold value, on the basis of a correction value determined in advance in accordance with a combination of the fluorescent reagent and a labeling target to be labeled with the fluorescent reagent.

On the basis of labeling target identification information associated with the specimen and reagent identification information associated with the fluorescent reagent, the threshold value determination unit may acquire the correction value from a correction data storage unit that stores the labeling target identification information, the reagent identification information, and the correction value in association with each other.

The threshold value determination unit may determine the positive threshold value for each of a plurality of observation regions defined by sectioning the stained fluorescence component image.

The threshold value determination unit may determine the positive threshold value for each of the plurality of observation regions defined by a user.

The threshold value determination unit may specify a noise component included in the stained specimen fluorescence spectrum, and define the plurality of observation regions by sectioning the stained fluorescence component image in accordance with the noise component.

The threshold value determination unit may determine a correctable range of the positive threshold value, and the threshold value output unit may output the positive threshold value and information indicating the correctable range.

Another aspect of the present disclosure relates to a microscope system including: a light irradiation unit configured to emit excitation light that excites a fluorescent reagent; an imaging device configured to image a specimen being irradiated with the excitation light, to acquire a specimen fluorescence spectrum; and an information processing apparatus configured to analyze the specimen fluorescence spectrum, in which the information processing apparatus includes: a first separation unit configured to separate a stained specimen fluorescence spectrum into a stained fluorescence component image containing the fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent; a second separation unit configured to separate an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent; and a threshold value determination unit configured to determine a positive threshold value that is to be compared with image data of a plurality of image sections included in the stained fluorescence component image on the basis of the unstained fluorescence component image, the positive threshold value being a criterion for determining whether or not each of the plurality of image sections corresponds to a positive cell image.

The microscope system may include a presentation information generation unit configured to generate presentation information that is displayed on a display unit and includes threshold value information indicating the positive threshold value.

The threshold value determination unit may determine a correctable range of the positive threshold value, and the presentation information may include correctable range information indicating the correctable range.

The microscope system may include an analysis unit configured to perform analysis on the basis of the positive threshold value.

Another aspect of the present disclosure relates to an information processing method including: a process of separating a stained specimen fluorescence spectrum into a stained fluorescence component image containing a fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent; a process of separating an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent; a process of determining a positive threshold value that is to be compared with image data of a plurality of image sections included in the stained fluorescence component image on the basis of the unstained fluorescence component image, the positive threshold value being a criterion for determining whether or not each of the plurality of image sections corresponds to a positive cell image; and a process of outputting the positive threshold value.

### BRIEF DESCRIPTION OF DRAWINGS

FIG. 1 is a block diagram illustrating a configuration example of an information processing system.

FIG. 2A is a specific example of a fluorescence spectrum acquired by a fluorescence signal acquisition unit.

FIG. 2B is a specific example of a fluorescence spectrum acquired by the fluorescence signal acquisition unit.

FIG. 2C is a specific example of a fluorescence spectrum acquired by the fluorescence signal acquisition unit.

FIG. 2D is a specific example of a fluorescence spectrum acquired by the fluorescence signal acquisition unit.

FIG. 3 is a view illustrating an example of a method for generating a joined fluorescence spectrum by a joining unit.

FIG. 4 is a graph illustrating an example of a joined fluorescence spectrum generated from the fluorescence spectra illustrated in “A” to “D” of FIG. 3.

FIG. 5 is a diagram for explaining an outline of an example of an NMF.

FIG. 6 is a diagram illustrating an outline of an example of clustering.

FIG. 7 is a diagram illustrating an example of a functional configuration for determining a positive threshold value in an information processing apparatus.

FIG. 8 is a diagram illustrating an example of image spectrum data obtained in the information processing apparatus.

FIG. 9 is a flowchart illustrating an example of image processing (particularly, image processing based on a stained specimen fluorescence spectrum) performed in the information processing apparatus.

FIG. 10 is a flowchart illustrating an example of image processing (particularly, image processing based on an unstained specimen fluorescence spectrum) performed in the information processing apparatus.

FIG. 11 is a view illustrating a concept of an example of a stained autofluorescence component image.

FIG. 12 is a view illustrating a concept of an example of an autofluorescence reference spectrum.

FIG. 13 is a view illustrating a concept of an example of an arithmetic operation of calculating a pseudo stained autofluorescence spectrum from a stained autofluorescence component image and an autofluorescence reference spectrum.

FIG. 14 illustrates an example of a histogram of a stained fluorescence component image and an unstained fluorescence component image.

FIG. 15 is a view illustrating an example of a difference unstained norm image.

FIG. 16 is a view illustrating an example of a region indicating an outlier in a difference unstained norm image.

FIG. 17 is a view illustrating an example of an outlier region in an unstained fluorescence component image.

FIG. 18 illustrates an example of a histogram of an unstained fluorescence component image.

FIG. 19 illustrates an example of a histogram of an unstained fluorescence component image after being corrected on the basis of outlier data.

FIG. 20 illustrates an example of display of image information on a display unit.

FIG. 21 illustrates an example of display of image information on the display unit.

FIG. 22 illustrates an example of display of image information on the display unit.

FIG. 23 illustrates an example of correction values stored in a correction data storage unit.

FIG. 24 illustrates an example of correction values stored in the correction data storage unit.

FIG. 25 is a block diagram illustrating a configuration example of a microscope system.

FIG. 26 is a schematic view for explaining an example of a method for calculating the number of fluorescent molecules or the number of antibodies in one pixel.

FIG. 27 is a block diagram illustrating a hardware configuration example of the information processing apparatus.

### MODE FOR CARRYING OUT THE INVENTION

Hereinafter, a typical embodiment of the present disclosure will be exemplarily described with reference to the drawings.

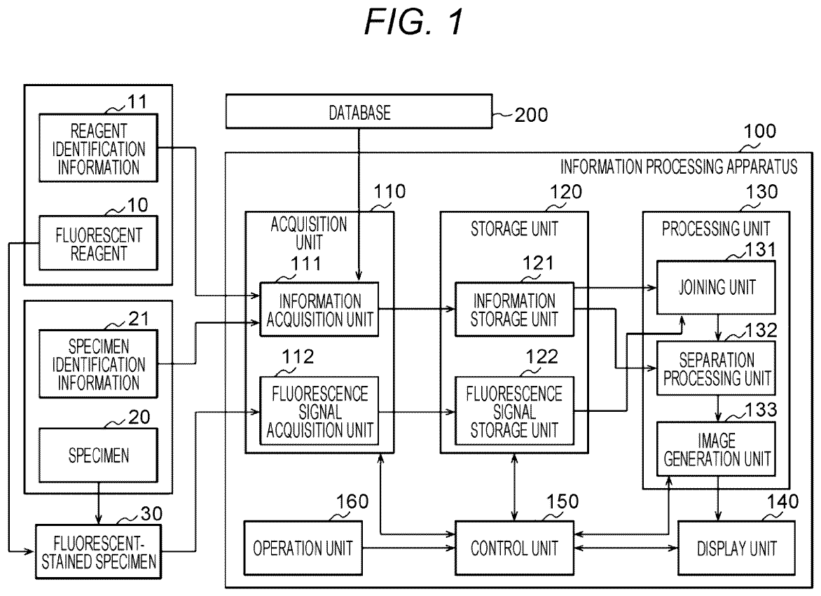

With reference to FIG. 1, a configuration example of an information processing system according to an embodiment will be described. The information processing system illustrated in FIG. 1 includes an information processing apparatus 100 and a database 200.

### (Fluorescent Reagent 10)

A fluorescent reagent 10 is a chemical used for staining a specimen 20. The fluorescent reagent 10 is, for example, a fluorescent antibody (including a primary antibody that is used for direct labeling or a secondary antibody that is used for indirect labeling), a fluorescent probe, a nuclear staining reagent, or the like, but a type of the fluorescent reagent 10 is not limited thereto. The fluorescent reagent 10 is managed by being given identification information (hereinafter referred to as “reagent identification information 11”) that enables identification of the fluorescent reagent 10 or a production lot of the fluorescent reagent 10. The reagent identification information 11 is, for example, bar code information (one-dimensional bar code information, two-dimensional bar code information, or the like), but is not limited thereto. Even in a case of the same product, properties of the fluorescent reagent 10 are different for each production lot in accordance with a production method, a state of a cell from which the antibody is acquired, and the like. For example, in the fluorescent reagent 10, a spectrum, a quantum yield, a fluorescent labeling rate, and the like are different for each production lot. Therefore, in the information processing system according to the present embodiment, the fluorescent reagent 10 is managed for each production lot by being given the reagent identification information 11. As a result, the information processing apparatus 100 can perform fluorescence separation also in consideration of a slight difference in properties that appears for each production lot.

### (Specimen 20)

The specimen 20 is prepared from an analyte or a tissue sample collected from a human body for the purpose of pathological diagnosis or the like. The specimen 20 may be a tissue slice, a cell, or a microparticle. Regarding the specimen 20, a type of tissue used (an organ or the like), a type of a target disease, an attribute of a subject (age, sex, blood type, race, and the like), or a lifestyle of the target (eating habits, exercise habits, smoking habits, and the like) is not limited. The tissue slice may include, for example, a slice before staining of a tissue slice as a staining target (hereinafter also simply referred to as “slice”), a slice adjacent to the stained slice, and a slice different from the stained slice in the same block (sampled from the same location as the stained slice). Furthermore, the tissue slice may include a slice in a different block (sampled from a location different from that of the stained slice) in the same tissue, a slice collected from a different patient, and the like.

The specimen 20 is managed by being given identification information (hereinafter referred to as “specimen identification information 21”) that enables identification of the specimen 20. Similarly to the reagent identification information 11, the specimen identification information 21 is, for example, bar code information (one-dimensional bar code information, two-dimensional bar code information, or the like), but is not limited thereto. The specimen 20 has different properties in accordance with a type of tissue used, a type of a target disease, an attribute of a subject, a lifestyle of the subject, or the like. For example, in the specimen 20, a measurement channel, a spectrum, or the like varies in accordance with the type of tissue used or the like. In the information processing system according to the present embodiment, the specimen 20 is individually managed by being given the specimen identification information 21. As a result, the information processing apparatus 100 can perform fluorescence separation also in consideration of a slight difference in properties appearing for each specimen 20.

### (Fluorescent-Stained Specimen 30)

A fluorescent-stained specimen 30 is made by staining the specimen 20 with the fluorescent reagent 10. In the present embodiment, in the fluorescent-stained specimen 30, it is assumed that the specimen 20 is stained with one or more fluorescent reagents 10. However, the number of fluorescent reagents 10 used for staining the specimen 20 is not limited. A staining method is determined by a combination of the specimen 20 and the fluorescent reagent 10, or the like, but is not particularly limited.

In a case of using a specimen not labeled with the fluorescent reagent 10 (hereinafter referred to as “fluorescent-unstained specimen”), for example, the specimen 20 can be used as it is as the fluorescent-unstained specimen without being stained with the fluorescent reagent 10.

### (Information Processing Apparatus 100)

As illustrated in FIG. 1, the information processing apparatus 100 includes an acquisition unit 110, a storage unit 120, a processing unit 130, a display unit 140, a control unit 150, and an operation unit 160. The information processing apparatus 100 can be configured by, for example, a fluorescence microscope system, but is not necessarily limited thereto, and can include various devices. The information processing apparatus 100 may be configured by, for example, a personal computer (PC).

### (Acquisition Unit 110)

The acquisition unit 110 acquires information to be used for various types of processing of the information processing apparatus 100. The acquisition unit 110 illustrated in FIG. 1 includes an information acquisition unit 111 and a fluorescence signal acquisition unit 112.

### (Information Acquisition Unit 111)

The information acquisition unit 111 acquires information regarding the fluorescent reagent 10 (hereinafter referred to as “reagent information”) and information regarding the specimen 20 (hereinafter referred to as “specimen information”). More specifically, the information acquisition unit 111 acquires the reagent identification information 11 given to the fluorescent reagent 10 used to generate the fluorescent-stained specimen 30 and the specimen identification information 21 given to the fluorescent-stained specimen 30 and/or the specimen 20 used to generate the fluorescent-unstained specimen. For example, the information acquisition unit 111 acquires, as barcode information, the reagent identification information 11 and the specimen identification information 21 given to the fluorescent reagent 10 and the specimen 20, by using a barcode reader or the like. Then, the information acquisition unit 111 acquires the reagent information from the database 200 on the basis of the reagent identification information 11, and acquires the specimen information from the database 200 on the basis of the specimen identification information 21. The information acquisition unit 111 stores the acquired information into an information storage unit 121 described later.

In the present embodiment, the specimen information includes a joined autofluorescence reference spectrum, and the reagent information includes a joined fluorescence reference spectrum. The joined autofluorescence reference spectrum is obtained by joining spectra of an autofluorescent substance in the specimen 20 in a wavelength direction. The joined fluorescence reference spectrum is obtained by joining spectra of a fluorescent substance in the fluorescent-stained specimen 30 in a wavelength direction. Note that the joined autofluorescence reference spectrum and the joined fluorescence reference spectrum are also simply referred to as “autofluorescence reference spectrum” and “fluorescence reference spectrum”, respectively, and the joined autofluorescence reference spectrum and the joined fluorescence reference spectrum are collectively referred to as “reference spectrum”.

### (Database 200)

The database 200 is a device that manages information such as the reagent information and the specimen information. More specifically, the database 200 manages the reagent identification information 11 and the reagent information in association with each other, and manages the specimen identification information 21 and the specimen information in association with each other. The information acquisition unit 111 can acquire the reagent information from the database 200 on the basis of the reagent identification information 11 of the fluorescent reagent 10, and can acquire the specimen information from the database 200 on the basis of the specimen identification information 21 of the specimen 20. The database 200 illustrated in FIG. 1 is connected to the information processing apparatus 100 (particularly, the acquisition unit 110 (information acquisition unit 111)) via a network.

The reagent information managed by the database 200 is assumed to be information including a measurement channel unique to a fluorescent substance of the fluorescent reagent 10 and a fluorescence reference spectrum, but is not necessarily limited thereto. The “measurement channel” is a concept indicating a fluorescent substance contained in the fluorescent reagent 10. Since the number of fluorescent substances varies depending on the fluorescent reagent 10, the measurement channel is managed in association with each fluorescent reagent 10 as the reagent information. Furthermore, the fluorescence reference spectrum included in the reagent information is a fluorescence spectrum of each fluorescent substance included in the measurement channel.

The specimen information managed by the database 200 is assumed to be information including a measurement channel unique to an autofluorescent substance of the specimen 20 and an autofluorescence reference spectrum, but is not necessarily limited to this information. The “measurement channel” is a concept indicating an autofluorescent substance contained in the specimen 20, and is a concept indicating, as an example, hemoglobin, archidonic acid, catalase, collagen, FAD, NADPH, and ProLongDiamond. Since the number of autofluorescent substances varies depending on the specimen 20, the measurement channel is managed in association with each specimen 20 as the specimen information. Furthermore, the autofluorescence reference spectrum included in the specimen information is an autofluorescence spectrum of each autofluorescent substance included in the measurement channel. Note that information managed by the database 200 is not necessarily limited to the information described above.

### (Fluorescence Signal Acquisition Unit 112)

The fluorescence signal acquisition unit 112 acquires a plurality of fluorescence signals acquired by irradiating the fluorescent-stained specimen 30 with a plurality of beams of excitation light having different wavelengths (that is, a plurality of fluorescence signals individually corresponding to the plurality of beams of excitation light). More specifically, by receiving light from the fluorescent-stained specimen 30 and outputting a detection signal corresponding to an amount of the received light, the fluorescence signal acquisition unit 112 acquires a fluorescence spectrum of the fluorescent-stained specimen 30 on the basis of the detection signal. Here, characteristics (including, for example, a wavelength and light intensity) of the excitation light are determined on the basis of reagent information and the like (that is, information regarding the fluorescent reagent 10, and the like). Note that the fluorescence signal mentioned here is not particularly limited as long as the signal originates from fluorescence, and may be, for example, a fluorescence spectrum.

The fluorescence signal acquisition unit 112 can acquire a plurality of fluorescence signals (fluorescence spectra) related to a fluorescent-unstained specimen, by irradiating the fluorescent-unstained specimen with a plurality of beams of excitation light by using a similar method.

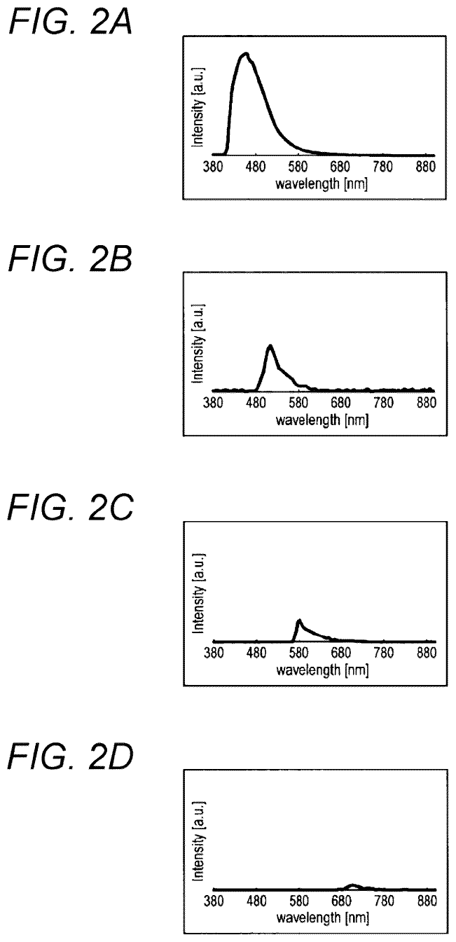

FIGS. 2A to 2D are specific examples of fluorescence spectra acquired by the fluorescence signal acquisition unit 112. The fluorescent-stained specimen 30 regarding FIGS. 2A to 2D contains four fluorescent substances: DAPI, CK/AF488, PgR/AF594, and ER/AF647. FIGS. 2A to 2D illustrate examples of fluorescence spectra acquired by irradiating the fluorescent-stained specimen 30 with excitation light having excitation wavelengths of 392 [nm](FIG. 2A), 470 [nm] (FIG. 2B), 549 [nm] (FIG. 2C), and 628 [nm] (FIG. 2D) for the individual fluorescent substances. Note that, since energy is emitted for fluorescence emission, the fluorescence wavelength is shifted to a longer wavelength side than the excitation wavelength (Stokes shift). Furthermore, a fluorescent substance contained in the fluorescent-stained specimen 30 and an excitation wavelength of the excitation light to be emitted are not limited to the example described above. The fluorescence signal acquisition unit 112 stores the acquired fluorescence spectrum into a fluorescence signal storage unit 122 (see FIG. 1) described later.

### (Storage Unit 120)

The storage unit 120 illustrated in FIG. 1 stores information to be used for various types of processing of the information processing apparatus 100 or information output by the various types of processing. As illustrated in FIG. 1, the storage unit 120 of the present embodiment includes the information storage unit 121 and the fluorescence signal storage unit 122.

### (Information Storage Unit 121)

The information storage unit 121 stores reagent information and specimen information acquired by the information acquisition unit 111.

### (Fluorescence Signal Storage Unit 122)

The fluorescence signal storage unit 122 stores a fluorescence signal of the fluorescent-stained specimen 30 acquired by the fluorescence signal acquisition unit 112. Furthermore, the fluorescence signal storage unit 122 also stores a fluorescence signal of a fluorescent-unstained specimen acquired by the fluorescence signal acquisition unit 112.

### (Processing Unit 130)

The processing unit 130 performs various types of processing including processing of performing fluorescence separation (that is, color separation processing). As illustrated in FIG. 1, the processing unit 130 includes a joining unit 131, a separation processing unit 132, and an image generation unit 133.

### (Joining Unit 131)

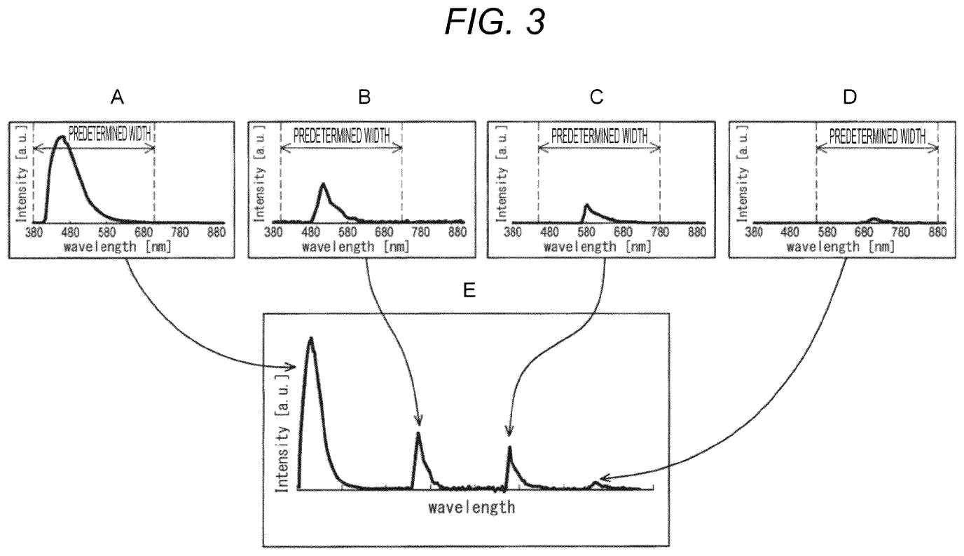

The joining unit 131 generates a joined fluorescence spectrum by joining at least some of a plurality of fluorescence spectra acquired by the fluorescence signal acquisition unit 112 (that is, a plurality of fluorescence spectra stored in the fluorescence signal storage unit 122) in a wavelength direction. For example, the joining unit 131 extracts data having a predetermined width from each fluorescence spectrum so as to include a maximum value of fluorescence intensity for each of four fluorescence spectra (see reference signs “A” to“D” in FIG. 3) acquired by the fluorescence signal acquisition unit 112. A width of a wavelength band in which the joining unit 131 extracts data may be determined on the basis of reagent information, an excitation wavelength, a fluorescence wavelength, and the like, or may be different for each fluorescent substance. That is, the width of the wavelength band in which the joining unit 131 extracts data may be different between the fluorescence spectra illustrated in “A” to“D” of FIG. 3. Then, as indicated by “E” in FIG. 3, the joining unit 131 generates one joined fluorescence spectrum by joining the extracted data to each other in the wavelength direction. Note that, since the joined fluorescence spectrum includes data extracted from the plurality of fluorescence spectra, the wavelengths are not necessarily continuous at a boundary between the joined data.

The joining unit 131 of the present embodiment joins a plurality of fluorescence spectra in the wavelength direction after aligning intensity of excitation light corresponding to each of the plurality of fluorescence spectra (in other words, after correcting the plurality of fluorescence spectra on the basis of the intensity of the excitation light). More specifically, the joining unit 131 performs joining of the plurality of fluorescence spectra, after aligning the intensity of the excitation light corresponding to each of the plurality of fluorescence spectra by dividing each fluorescence spectrum by an excitation power density indicating the intensity of the excitation light. As a result, a fluorescence spectrum that is to be obtained in a case where the fluorescent-stained specimen 30 is irradiated with the excitation light having the same intensity is obtained. Furthermore, in a case where the intensity of the irradiated excitation light is different, intensity of a spectrum (hereinafter referred to as “absorption spectrum”) absorbed by the fluorescent-stained specimen 30 is also different according to the intensity of the excitation light. Therefore, by aligning the intensity of the excitation light corresponding to each of the plurality of fluorescence spectra as described above, the absorption spectrum can be appropriately evaluated.

The intensity of the excitation light in the present description may be excitation power or an excitation power density as described above. The excitation power or the excitation power density may be power or a power density obtained by actually measuring excitation light emitted from a light source, or may be power or a power density obtained from a drive voltage applied to the light source. Note that the intensity of the excitation light in the present description may be a value obtained by correcting the excitation power density described above by using an absorption rate for individual excitation light of a slice to be observed, an amplification rate of a detection signal in a detection system (a fluorescence signal acquisition unit or the like) that detects fluorescence emitted from the slice, or the like. That is, the intensity of the excitation light in the present description may be a power density of excitation light actually contributing to excitation of a fluorescent substance, a value obtained by correcting the power density with the amplification factor, or the like, of the detection system, or the like. By considering the absorption rate, the amplification rate, and the like, it is possible to appropriately correct the intensity of the excitation light that changes according to a change in a machine state or an environment, and thus, it is possible to generate a joined fluorescence spectrum that enables color separation with higher accuracy.

A correction value (also referred to as “intensity correction value”) based on the intensity of the excitation light for each fluorescence spectrum is not limited to a value for aligning the intensity of the excitation light corresponding to each of the plurality of fluorescence spectra, and the correction value may be variously changed. For example, signal intensity of a fluorescence spectrum having an intensity peak on a long wavelength side (also referred to as “long-wavelength side peak fluorescence spectrum”) tends to be lower than signal intensity of a fluorescence spectrum having an intensity peak on a short wavelength side (also referred to as “short-wavelength side peak fluorescence spectrum”). Therefore, in a case where both the long-wavelength side peak fluorescence spectrum and the short-wavelength side peak fluorescence spectrum are included in the joined fluorescence spectrum, the long-wavelength side peak fluorescence spectrum is hardly taken into account, and the short-wavelength side peak fluorescence spectrum may be mainly extracted in some cases. In this case, for example, by setting an intensity correction value for the long-wavelength side peak fluorescence spectrum to a larger value, it is possible to enhance separation accuracy of the short-wavelength side peak fluorescence spectrum.

Furthermore, the joining unit 131 may correct a wavelength resolution of each of the plurality of fluorescence spectra to be joined, independently of other fluorescence spectra. For example, in a fluorescence spectrum of AF546 and a fluorescence spectrum of AF555, a spectrum shape and a peak wavelength are almost the same. The fluorescence spectrum of the AF555 and the fluorescence spectrum of the AF546 are different from each other in that fluorescence spectrum of the AF555 has a shoulder at a bottom portion on the high wavelength side, whereas the fluorescence spectrum of the AF546 does not have such a shoulder. As described above, in a case where two fluorescence spectra are close to each other, there arises a problem that it is difficult to perform color separation on the two fluorescence spectra through spectrum extraction.

Such a problem may be solved by increasing a wavelength resolution of the joined fluorescence spectrum in some cases. This indicates that, even in a case where a plurality of fluorescence spectra having close spectral shapes and peak wavelengths are used, color separation can be performed using the fluorescence spectra by increasing the wavelength resolution.

However, when the wavelength resolution is increased, a data amount of the joined fluorescence spectrum increases, and a necessary memory capacity, calculation cost in the fluorescence separation processing, and the like increase. Therefore, among the plurality of fluorescence spectra to be joined, the joining unit 131 corrects a fluorescence spectrum that is assumed to be difficult to be subjected to color separation so as to have a high wavelength resolution, and corrects a fluorescence spectrum that is assumed to be easy to be subjected to color separation so as to have a low wavelength resolution. As a result, it becomes possible to improve color separation accuracy while suppressing an increase in data amount.

Here, a method for generating a joined fluorescence spectrum by using the joining unit 131 will be described with specific examples. In the present example, similarly to the method for generating a joined fluorescence spectrum described above with reference to FIG. 3, the fluorescent-stained specimen 30 containing four fluorescent substances of DAPI, CK/AF488, PgR/AF594, and ER/AF647 is used. Exemplified is a case of joining four fluorescence spectra that are obtained by irradiating the fluorescent-stained specimen 30 with excitation light having excitation wavelengths of 392 nm, 470 nm, 549 nm, and 628 nm for the individual fluorescent substances.

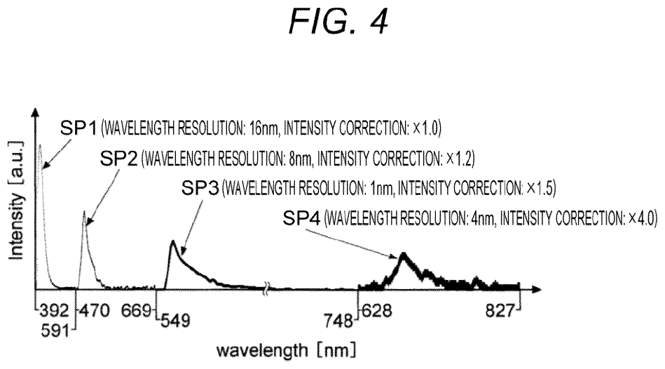

FIG. 4 is a graph illustrating an example of a joined fluorescence spectrum generated from the fluorescence spectra illustrated in “A” to “D” of FIG. 3. As illustrated in FIG. 4, the joining unit 131 extracts a fluorescence spectrum SP1 in a wavelength band of an excitation wavelength of 392 nm or more and 591 nm or less from the fluorescence spectrum illustrated in “A” of FIG. 3. Furthermore, the joining unit 131 extracts a fluorescence spectrum SP2 in a wavelength band of an excitation wavelength of 470 nm or more and 669 nm or less from the fluorescence spectrum illustrated in “B” of FIG. 3. Furthermore, the joining unit 131 extracts a fluorescence spectrum SP3 of a wavelength band of an excitation wavelength of 549 nm or more and 748 nm or less from the fluorescence spectrum illustrated in “C” of FIG. 3. Furthermore, the joining unit 131 extracts a fluorescence spectrum SP4 of a wavelength band of an excitation wavelength of 628 nm or more and 827 nm or less from the fluorescence spectrum illustrated in “D” of FIG. 3. Next, the joining unit 131 corrects a wavelength resolution of the extracted fluorescence spectrum SP1 to 16 nm (without correction of intensity), corrects intensity of the fluorescence spectrum SP2 to 1.2 times, and corrects a wavelength resolution to 8 nm. Furthermore, the joining unit 131 corrects intensity of the fluorescence spectrum SP3 to 1.5 times (without correction of a wavelength resolution), corrects intensity of the fluorescence spectrum SP4 to 4.0 times, and corrects a wavelength resolution to 4 nm. Then, the joining unit 131 generates the joined fluorescence spectrum illustrated in FIG. 4 by sequentially joining the corrected fluorescence spectra SP1 to SP4.

Note that FIG. 4 illustrates a joined fluorescence spectrum obtained by extracting and joining the fluorescence spectra SP1 to SP4 having a predetermined bandwidth (200 nm width in FIG. 4) from the excitation wavelength when the joining unit 131 acquires each fluorescence spectrum. However, the bandwidth of the fluorescence spectrum extracted by the joining unit 131 does not need to match between the fluorescence spectra, and may be different between the fluorescence spectra. That is, a region extracted from each fluorescence spectrum by the joining unit 131 may be any region including a peak wavelength of each fluorescence spectrum, and a wavelength band and a bandwidth of the extracted region may be appropriately changed. When the wavelength band and the bandwidth of the region to be extracted are changed, a shift of the spectrum wavelength due to the Stokes shift may be considered. In this way, by extracting and using a limited wavelength band, a data amount can be reduced, and thus fluorescence separation processing can be executed at a higher speed.

### (Separation Processing Unit 132)

The separation processing unit 132 illustrated in FIG. 1 performs the color separation processing on a fluorescence signal of the fluorescent-stained specimen 30 (that is, a stained specimen fluorescence spectrum) acquired by the fluorescence signal storage unit 122. Furthermore, the separation processing unit 132 performs the color separation processing on a fluorescence signal of a fluorescent-unstained specimen (that is, an unstained specimen fluorescence spectrum). As a result of the color separation processing, from the fluorescence signal of the fluorescent-stained specimen 30, a stained fluorescence component image generated by extracting a fluorescence image of a fluorescent reagent and a stained autofluorescence component image generated by extracting a fluorescence image of an autofluorescence component are derived as separate images. Similarly, from the fluorescence signal of the fluorescent-unstained specimen, an unstained fluorescence component image generated by extracting a fluorescence image of a fluorescent reagent and an unstained autofluorescence component image generated by extracting a fluorescence image of an autofluorescence component are derived as separate images.

For example, a least square method (LSM), a weighted least square method (WLSM), or the like may be used for the color separation processing. Furthermore, for example, non-negative matrix factorization (NMF), singular value decomposition (SVD), principal component analysis (PCA), or the like may be used for extracting the autofluorescence spectrum and/or the fluorescence spectrum.

### (About Least Square Method)

Here, a least square method that can be used in the color separation processing by the separation processing unit 132 will be described. The least square method is a calculation method for calculating a color mixing ratio by fitting a reference spectrum to a fluorescence spectrum that is a pixel value of each pixel in an input specimen fluorescence spectrum (for example, a stained specimen fluorescence spectrum (stained specimen image)). Note that, the color mixing ratio is an index indicating a degree of mixing of individual substances. The following Formula (1) is a formula representing a residual obtained by subtracting a reference spectrum St (a fluorescence reference spectrum and an autofluorescence reference spectrum) mixed at a color mixing ratio “a”, from a fluorescence spectrum (Signal). Note that “Signal (1×number of channels)” in Formula (1) indicates that the fluorescence spectrum (Signal) exists as many as the number of channels of the wavelength. For example, Signal is a matrix representing one or more fluorescence spectra. Furthermore, “St (number of substances×number of channels)” indicates that the reference spectrum exists as many as the number of channels of the wavelength for individual substances (a fluorescent substance and an autofluorescent substance). For example, St is a matrix representing one or more reference spectra. Furthermore, “a (1×number of substances)” indicates that the color mixing ratio “a” is provided for individual substances (a fluorescent substance and an autofluorescent substance). For example, “a” is a matrix representing a color mixing ratio of each reference spectrum in the fluorescence spectrum.

$$\\ \begin{matrix}[ Expression 1 ] & \\ Signal ( 1 \times NUMBER OF CHANNELS ) - a ( 1 \times NUMBER OF SUBSTANCES ) * St ( NUMBER OF SUBSTANCES \times NUMBER OF CHANNELS ) & ( 1 )\end{matrix}$$

Then, the separation processing unit 132 calculates the color mixing ratio “a” of each substance in which a square sum of Formula (1) representing the residual is minimized. The square sum of the residual is minimized in a case where a result of partial differentiation with respect to the color mixing ratio “a” is 0 in Formula (1) representing the residual. Therefore, the separation processing unit 132 calculates the color mixing ratio “a” of each substance in which the square sum of the residual is minimized by solving the following Formula (2). Note that “St′” in Formula (2) indicates a transposed matrix of the reference spectrum St. Furthermore, “inv (St*St′)” indicates an inverse matrix of St*St′.

$$\\ \begin{matrix}[ Expression 2 ] & \\ \begin{matrix}\frac{δ ( Signal - a * St )}{δ a} = 0 \\ ⇔ 2 ( Signal - a * St ) * {St}^{{}_{} ′} = 0 \\ ⇔ ( Signal - a * St ) {St}^{{}_{} ′} = 0 \\ ⇔ Signal * {St}^{{}_{} ′} - a * ( St * {St}^{{}_{} ′} ) = 0 \\ ⇔ a = Signal * {St}^{{}_{} ′} * inv ( St * {St}^{{}_{} ′} )\end{matrix} & ( 2 )\end{matrix}$$

Here, specific examples of individual values of the above-described Formula (1) are shown in the following Formulas (3) to (5). The examples of the Formulas (3) to (5) indicate a case where the reference spectra (St) of three substances (the number of substances is three) are mixed at different color mixing ratios “a” in the fluorescence spectrum (Signal).

$$\\ \begin{matrix}[ Expression 3 ] & \\ St = ( \begin{matrix}50 & 100 & 60 & 25 & 4 \\ 10 & 20 & 100 & 20 & 8 \\ 0.1 & 11 & 30 & 100 & 50\end{matrix} ) & ( 3 )\end{matrix}$$

$$\\ \begin{matrix}[ Expression 4 ] & \\ a = ( 321 ) & ( 4 )\end{matrix}$$

$$\\ \begin{matrix}[ Expression 5 ] & \\ Signal = a * St = ( 170.1 351 \; 410 \; 215 \; 78 ) & ( 5 )\end{matrix}$$

Then, a specific example of a calculation result of the above-described Formula (2) based on individual values of the Formulas (3) and (5) is shown in the following Formula (6). As can be seen from Formula (6), “a=(3 2 1)” (that is, the same value as the above-described Formula (4)) is correctly calculated as the calculation result.

$$\\ \begin{matrix}[ Expression 6 ] & \\ a = Signal * {St}^{{}_{} ′} * inv ( St * {St}^{{}_{} ′} ) = ( 321 ) & ( 6 )\end{matrix}$$

Note that, as described above, the separation processing unit 132 may extract a spectrum for each fluorescent substance from a fluorescence spectrum by performing calculation related to the weighted least square method instead of the least square method. In the weighted least square method, by using the fact that noise of the fluorescence spectrum (Signal), which is a measured value, has a Poisson distribution, weighting is performed so as to emphasize an error of a low signal level. However, an upper limit value at which weighting is not performed by the weighted least square method is set as an offset value. The offset value is determined by characteristics of a sensor used for measurement, and it is necessary to separately optimize the offset value in a case where an imaging element is used as the sensor. In a case of performing the weighted least square method, the reference spectrum St in the above-described Formulas (1) and (2) is replaced with St_ represented by the following Formula (7). Note that the following Formula (7) means that St_ is calculated by dividing (in other words, performing element division on) each element (each component) of St represented by the matrix by each corresponding element (each component) in the “Signal+Offset value” also represented by the matrix.

$$\\ \begin{matrix}[ Expression 7 ] & \\ {St}_{-} = \frac{St}{Signal + Offset VALUE} & ( 7 )\end{matrix}$$

Here, the following Formula (8) shows a specific example of St_ represented by the above-described Formula (7) in a case where the Offset value is 1 and values of the reference spectrum St and the fluorescence spectrum Signal are represented by the above-described Formulas (3) and (5), respectively.

$$\\ \begin{matrix}[ Expression 8 ] & \\ {St}_{-} = \frac{St}{Signal + Offset VALUE} = ( \begin{matrix}0.2922 & 0.2841 & 0.146 & 0.1157 & 0.0506 \\ 0.0584 & 0.0568 & 0.2433 & 0.0926 & 0.1013 \\ 5.8445 {e}^{{}_{} - 5} & 0.0313 & 0.073 & 0.463 & 0.6329\end{matrix} ) & ( 8 )\end{matrix}$$

Then, a specific example of a calculation result of the color mixing ratio “a” in this case is shown in the following Formula (9). As can be seen from Formula (9), “a=(3 2 1)” is correctly calculated as the calculation result.

$$\\ \begin{matrix}[ Expression 9 ] & \\ a = Signal * {St}_{-}^{{}_{} ′} * inv ( St * {St}_{-}^{{}_{} ′} ) = ( 321 ) & ( 9 )\end{matrix}$$

### (Non-Negative Matrix Factorization (NMF))

A description will be given to non-negative matrix factorization (NMF) used by the separation processing unit 132 to extract an autofluorescence spectrum and/or a fluorescence spectrum. However, without limiting to the non-negative matrix factorization (NMF), and singular value decomposition (SVD), principal component analysis (PCA), or the like may be used.

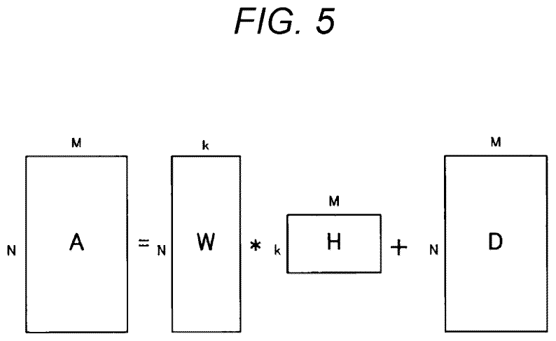

FIG. 5 is a diagram for explaining an outline of the NMF. As illustrated in FIG. 5, the NMF decomposes a matrix A of non-negative N rows and M columns (N×M) into a matrix W of non-negative N rows and k columns (N×k) and a matrix H of non-negative k rows and M columns (k×M). The matrix W and the matrix H are determined such that a mean square residual D between the matrix A and a product (W*H) of the matrix W and the matrix H is minimized. In the present embodiment, the matrix A corresponds to a spectrum (N is the number of pixels, and M is the number of wavelength channels) before the autofluorescence reference spectrum is extracted. The matrix H is the extracted autofluorescence reference spectrum (k is the number of autofluorescence reference spectra (in other words, the number of autofluorescent substances)). M corresponds to the number of wavelength channels. Here, the mean square residual D is represented by the following Formula (10). Note that the “norm (D, ‘fro’)” refers to a Frobenius norm of the mean square residual D.

$$\\ \begin{matrix}[ Expression 10 ] & \\ D = \frac{norm ( {D}^{{}_{} ′} , {fro}^{{}_{} ′} )}{\sqrt{N * M}} & ( 10 )\end{matrix}$$

For factorization in NMF, an iterative method starting with random initial values for the matrix W and the matrix H is used. In the NMF, the value of k (the number of autofluorescence reference spectra) is essential, but the initial values of the matrix W and the matrix H are not essential and can be set as options, and a solution is constant when the initial values of the matrix W and the matrix H are set. Whereas, in a case where the initial values of the matrix W and the matrix H are not set, these initial values are randomly set, and the solution is not constant.

The specimen 20 has different properties and also has different autofluorescence spectra in accordance with a type of tissue used, a type of a target disease, an attribute of a subject, a lifestyle of the subject, or the like. Therefore, the information processing apparatus 100 can achieve more accurate color separation processing by actually measuring the autofluorescence reference spectrum for each specimen 20 as described above.

Note that the matrix A, which is an input of the NMF, is a matrix including the same number of rows as the number of pixels N(=Hpix×Vpix) of the stained specimen image and the same number of columns as the number of wavelength channels M, as described above. Therefore, in a case where the number of pixels of the stained specimen image is large or in a case where the number of wavelength channels M is large, the matrix A becomes a very large matrix, calculation cost of the NMF increases, and a processing time becomes long.

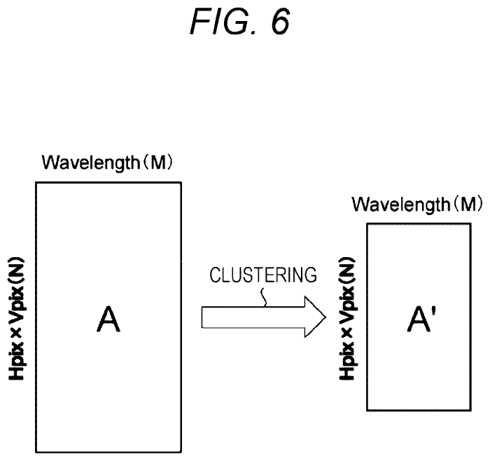

In such a case, for example, as illustrated in FIG. 6, by clustering the number of pixels N(=Hpix×Vpix) of the stained image into a designated number of classes N (<Hpix×Vpix), it is possible to suppress redundancy of a processing time due to enlargement of the matrix A.

In the clustering, for example, spectra similar in the wavelength direction and the intensity direction among stained images are classified into the same class. As a result, an image having a smaller number of pixels than the stained image is generated, so that the size of a matrix A′ using this image as an input can be reduced.

### (Image Generation Unit 133)

The image generation unit 133 illustrated in FIG. 1 generates image information on the basis of image spectrum data (including a stained fluorescence component image) obtained as a result of a series of processing (including the color separation processing on a fluorescence spectrum) in the separation processing unit 132. For example, the image generation unit 133 can generate the image information by using a fluorescence spectrum corresponding to one or more fluorescent substances, or can generate the image information by using an autofluorescence spectrum corresponding to one or more autofluorescent substances. Note that the number and combination of fluorescent substances (molecules) or autofluorescent substances (molecules) used by the image generation unit 133 to generate the image information are not particularly limited. Furthermore, in a case where various types of processing (for example, segmentation, S/N value calculation, and the like) using the fluorescence spectrum or the autofluorescence spectrum after separation are performed, the image generation unit 133 may generate image information indicating results of the various types of processing.

### (Display Unit 140)

The display unit 140 presents image information to an implementer (user), by displaying the image information generated by the image generation unit 133 on a display. Note that a type of the display used as the display unit 140 is not particularly limited. Furthermore, although not described in detail, the image information generated by the image generation unit 133 may be presented to the implementer by being projected by a projector (display unit 140) or printed by a printer (display unit 140). In other words, a method of outputting the image information is not particularly limited.

### (Operation Unit 160)

The operation unit 160 receives an operation input from the implementer (user). More specifically, the operation unit 160 includes various input means such as a keyboard, a mouse, a button, a touch panel, and/or a microphone, and the implementer can perform various inputs to the information processing apparatus 100 by operating the input means. Information regarding the input performed via the operation unit 160 is provided to the control unit 150.

### (Control Unit 150)

The control unit 150 is a functional configuration that comprehensively controls overall processing performed by the information processing apparatus 100. For example, the control unit 150 controls a start, an end, and the like of various types of processing as described above, on the basis of operation input performed by the implementer via the operation unit 160. Examples of the various types of processing include, for example, adjustment processing of a placement position of the fluorescent-stained specimen 30, irradiation processing with excitation light on the fluorescent-stained specimen 30, spectrum acquisition processing, generation processing of an autofluorescence component correction image, color separation processing, image information generation processing, image information display processing, and the like. Note that control contents of the control unit 150 are not particularly limited. For example, the control unit 150 may control processing (for example, processing related to an operating system (OS)) generally performed in a general-purpose computer, a PC, a tablet PC, or the like.

The above-described system configuration described with reference to FIG. 1 is merely an example, and the configuration of the above-described information processing system is not limited to the above-described example. For example, the information processing apparatus 100 may not necessarily include all of the configurations illustrated in FIG. 1, or may include a configuration not illustrated in FIG. 1.

### (Detection of Positive Cell Image)

As described above, the separation processing unit 132 (see FIG. 1) performs the color separation processing to separate a stained specimen fluorescence spectrum into a stained fluorescence component image containing a fluorescent reagent and a stained autofluorescence component image containing an autofluorescence component. As a result, a fluorescence signal originating from an autofluorescent substance, which is a problem in a captured image of the fluorescent-stained specimen, can be effectively separated from a fluorescence signal originating from a fluorescent substance that is an analysis target.

Then, a positive cell image in the stained fluorescence component image can be accurately detected by analyzing the stained fluorescence component image from which the autofluorescence component has been removed or reduced.

Specifically, it is possible to determine whether or not each image section corresponds to the positive cell image, by comparing a positive threshold value with image data (for example, characteristic data such as a luminance value) of a plurality of image sections included in the stained fluorescence component image. Each of the plurality of image sections mentioned here may be constituted by individual pixel constituting the stained fluorescence component image, or may be constituted by a set of two or more pixels.

As described above, in order to detect the positive cell image in the stained fluorescence component image, it is necessary to determine the positive threshold value which is a criterion for determining whether or not each image section corresponds to the positive cell image.

Hereinafter, a typical example of a device and a technique for determining the positive threshold value for the stained fluorescence component image will be described.

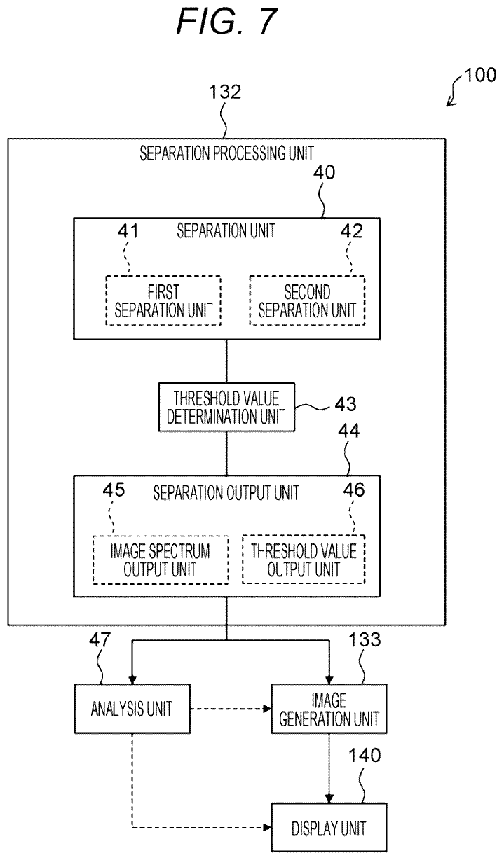

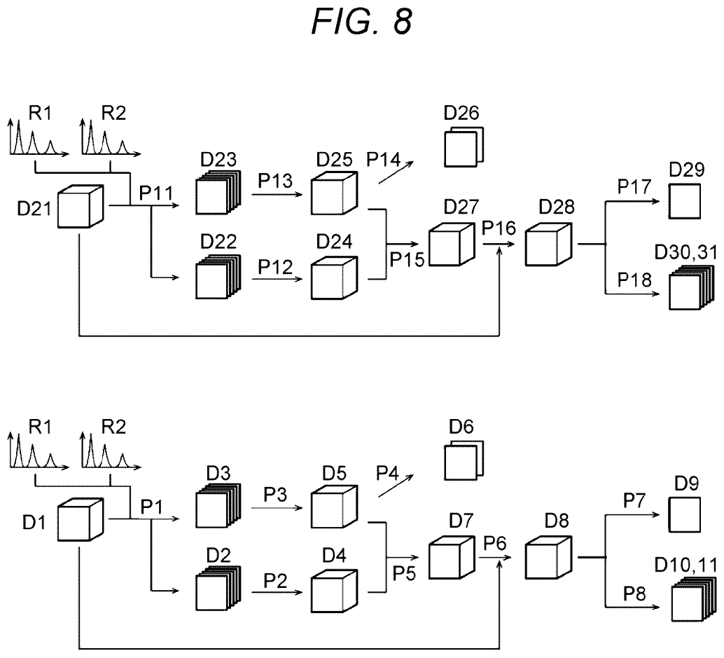

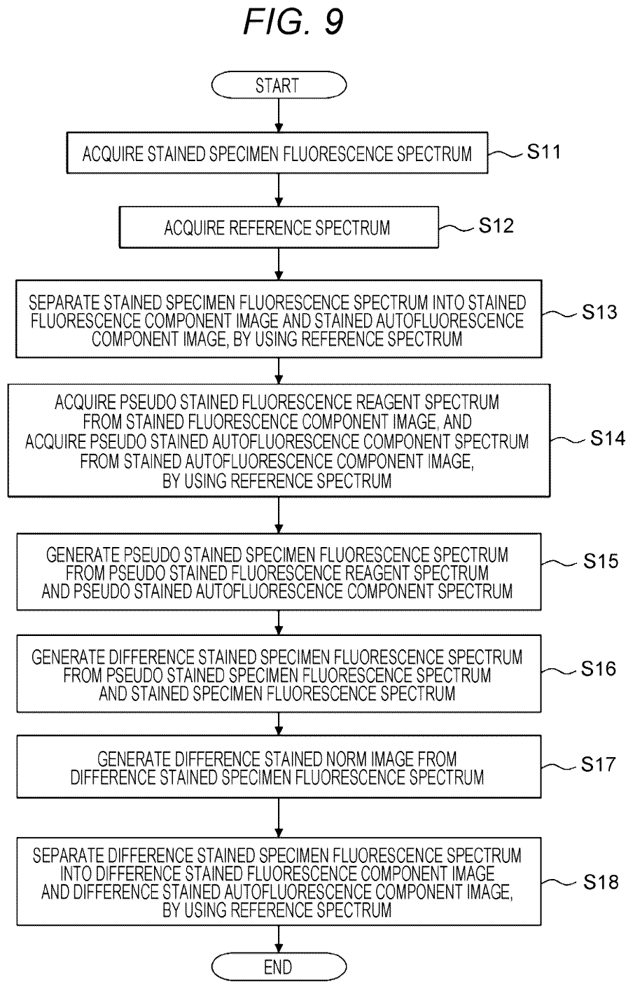

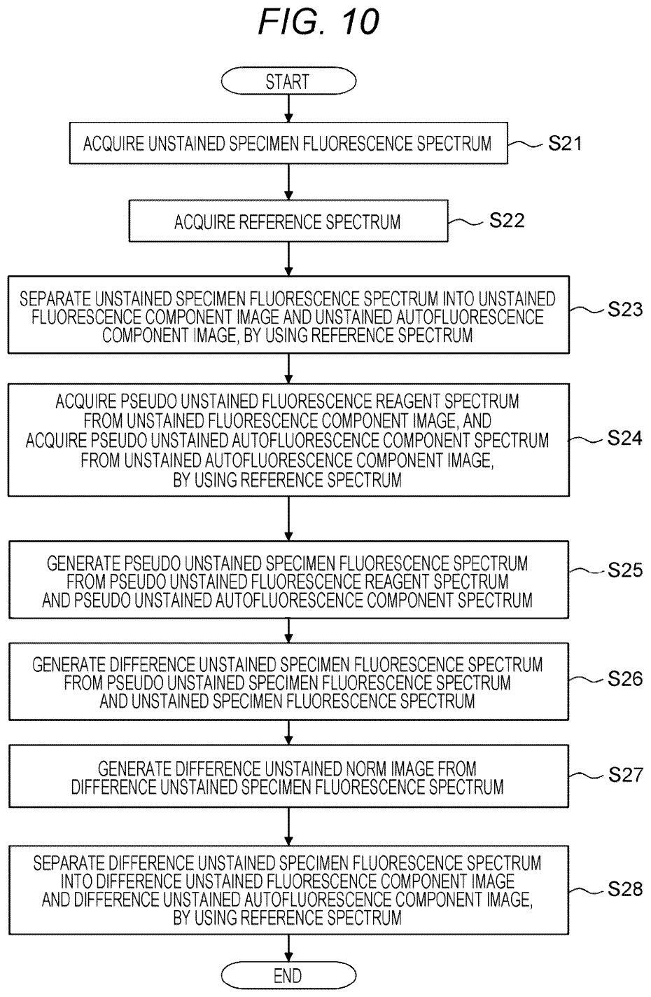

FIG. 7 is a diagram illustrating an example of a functional configuration for determining the positive threshold value in the information processing apparatus 100. FIG. 8 is a diagram illustrating an example of image spectrum data obtained by the information processing apparatus 100. FIG. 9 is a flowchart illustrating an example of image processing (particularly, image processing based on a stained specimen fluorescence spectrum) performed by the information processing apparatus 100. FIG. 10 is a flowchart illustrating an example of image processing (particularly, image processing based on an unstained specimen fluorescence spectrum) performed by the information processing apparatus 100.

The separation processing unit 132 illustrated in FIG. 7 includes a separation unit 40, a threshold value determination unit 43, and a separation output unit 44.

(Separation Unit 40) The separation unit 40 acquires fluorescence spectra D1 and D21 acquired by irradiating a specimen with excitation light, and reference spectra R1 and R2 (S11 and S12 in FIG. 9; S21 and S22 in FIG. 10).

The specimen handled here may include not only the fluorescent-stained specimen 30 obtained by labeling a specimen with a fluorescent reagent but also a fluorescent-unstained specimen that is not labeled with a fluorescent reagent. A fluorescence spectrum obtained by imaging the fluorescent-stained specimen being irradiated with the excitation light is referred to as a stained specimen fluorescence spectrum D1 (see FIG. 8). Whereas, a fluorescence spectrum obtained by imaging the fluorescent-unstained specimen being irradiated with the excitation light is referred to as an unstained specimen fluorescence spectrum D21.

As described above, the reference spectrum includes a fluorescence reference spectrum R1 indicating an original spectrum of the fluorescent reagent 10 as a reference and an autofluorescence reference spectrum R2 indicating an original spectrum of the autofluorescent substance of the specimen 20 as a reference.

The separation unit 40 acquires the stained specimen fluorescence spectrum D1, the unstained specimen fluorescence spectrum D21, the fluorescence reference spectrum R1, and the autofluorescence reference spectrum R2.

The separation unit 40 of the present example acquires the stained specimen fluorescence spectrum D1 and the unstained specimen fluorescence spectrum D21 generated as a joined fluorescence spectrum by the above-described joining unit 131 (see FIG. 1). Therefore, the separation unit 40 may directly acquire the stained specimen fluorescence spectrum D1 and the unstained specimen fluorescence spectrum D21 from the joining unit 131. Alternatively, in a case where the joining unit 131 stores the stained specimen fluorescence spectrum D1 and the unstained specimen fluorescence spectrum D21 in the storage unit 120 illustrated in FIG. 1, the separation unit 40 may acquire the stained specimen fluorescence spectrum D1 and the unstained specimen fluorescence spectrum D21 from the storage unit 120.

Furthermore, the separation unit 40 acquires the fluorescence reference spectrum R1 and the autofluorescence reference spectrum R2 from the storage unit 120 (specifically, the information storage unit 121) illustrated in FIG. 1.

Then, the separation unit 40 separates the fluorescence spectra D1 and D21 into a fluorescence component image and an autofluorescence component image by using the reference spectra R1 and R2 (color separation processing P1 and P11 in FIG. 8; S13 in FIG. 9; S23 in FIG. 10).

The color separation processing for the stained specimen fluorescence spectrum D1 and the color separation processing for the unstained specimen fluorescence spectrum D21 are basically performed in the same manner. Therefore, the color separation processing may be performed on both the stained specimen fluorescence spectrum D1 and the unstained specimen fluorescence spectrum D21 by using the common separation unit 40. However, the color separation processing for the stained specimen fluorescence spectrum D1 may be performed by a first separation unit 41, and the color separation processing for the unstained specimen fluorescence spectrum D21 may be performed by a second separation unit 42 different from the first separation unit 41.

The stained specimen fluorescence spectrum D1 is separated by the color separation processing P1 into a stained fluorescence component image D2 containing a fluorescent reagent and a stained autofluorescence component image D3 containing an autofluorescence component. Similarly, the unstained specimen fluorescence spectrum D21 is separated by the color separation processing P11 into an unstained fluorescence component image D22 containing a fluorescent reagent and an unstained autofluorescence component image D23 containing an autofluorescence component.

### (Threshold Value Determination Unit 43)

The threshold value determination unit 43 (see FIG. 7) determines a positive threshold value for the stained fluorescence component image D2, on the basis of image spectrum data obtained by processing (including the color separation processing P1 and P11 described above) in the separation unit 40 (a positive threshold value determination process).

The image spectrum data mentioned here may include the stained specimen fluorescence spectrum D1 and the unstained specimen fluorescence spectrum D21, and data derived from the stained specimen fluorescence spectrum D1 and the unstained specimen fluorescence spectrum D21.

The threshold value determination unit 43 can determine the positive threshold value for the stained fluorescence component image D2 by performing arbitrary processing on the basis of the image spectrum data received from the separation unit 40.

A typical example of a method for determining the positive threshold value in the threshold value determination unit 43 will be described later.

### (Separation Output Unit 44)

The separation output unit 44 outputs the positive threshold value determined by the threshold value determination unit 43 (a positive threshold value output process).

The separation output unit 44 of the present example also outputs the image spectrum data obtained by the processing in the separation unit 40 together with the positive threshold value. That is, the separation output unit 44 outputs the image spectrum data and the positive threshold value in association with each other.

Note that the separation output unit 44 may include, as separate units, an image spectrum output unit 45 that outputs the image spectrum data and a threshold value output unit 46 that outputs the positive threshold value.

Furthermore, the separation output unit 44 outputs the positive threshold value, but may not output the image spectrum data. In this case, the image spectrum data obtained in the separation unit 40 may be transmitted from the separation unit 40 to the storage unit 120 (for example, the fluorescence signal storage unit 122) illustrated in FIG. 1 and stored. The image spectrum data stored in the storage unit 120 may be appropriately read and used by another device (for example, an analysis unit 47 and the image generation unit 133 described later).

An output destination of the positive threshold value by the separation output unit 44 is not limited. Typically, the separation output unit 44 outputs the positive threshold value to the analysis unit 47 and/or the image generation unit 133, but may output the positive threshold value to another device or functional configuration unit.

### (Analysis Unit 47)

The analysis unit 47 performs arbitrary analysis on the basis of the positive threshold value output from the separation output unit 44. Typically, the analysis unit 47 analyzes the image spectrum data (for example, the stained fluorescence component image D2) on the basis of the positive threshold value. The analysis unit 47 can include, for example, analysis software (an application) that performs cell analysis processing such as cell count processing.

The positive threshold value provided from the separation output unit 44 to the analysis unit 47 can be automatically set to the positive threshold value to be used in the analysis processing performed in the analysis unit 47.

However, how the analysis unit 47 uses the positive threshold value output from the separation output unit 44 is not limited.

The analysis unit 47 may use the positive threshold value output from the separation output unit 44 as a fixed value or an initial value. In a case where the positive threshold value output from the separation output unit 44 is used as an initial value in the analysis unit 47, a positive threshold value corrected as necessary can be used in actual analysis in the analysis unit 47.

The analysis unit 47 described above may be provided as a part of the information processing apparatus 100 (see FIG. 1) or may be provided separately from the information processing apparatus 100.

### (Image Generation Unit 133)

The image generation unit 133 generates image information to be displayed on the display unit 140.

The image information includes presentation information based on the positive threshold value, and the image generation unit 133 serves as a presentation information generation unit that generates the presentation information.

In the present embodiment, the presentation information includes threshold value information indicating the positive threshold value.

The user can check the positive threshold value by viewing the presentation information (particularly the threshold value information) displayed on the display unit 140.

A specific method for generating the image information in the image generation unit 133 is not limited.

For example, the image generation unit 133 may generate the image information (including the presentation information) on the basis of the positive threshold value received from the separation output unit 44 and the stained fluorescence component image D2.

Furthermore, the image generation unit 133 may receive a result of analysis by the analysis unit 47, and generate the image information (including the presentation information) on the basis of the analysis result.

Although the image generation unit 133 illustrated in FIG. 1 is provided as a part of the information processing apparatus 100, the image generation unit 133 may be provided separately from the information processing apparatus 100.

### (Display Unit 140)

The display unit 140 displays the image information received from the image generation unit 133 and presents the image information to the user. Note that the display unit 140 may receive the image information based on an analysis result of the analysis unit 47 from the analysis unit 47, and display the image information.

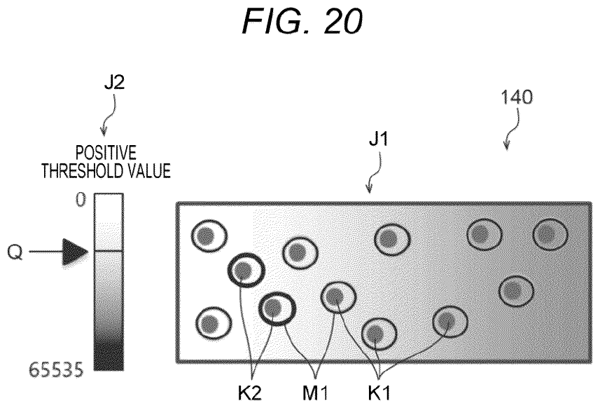

A display example of the image information on the display unit 140 will be described later (see FIGS. 20 to 22), but a display mode of the image information on the display unit 140 is not limited.

Although the display unit 140 illustrated in FIG. 1 is provided as a part of the information processing apparatus 100, the display unit 140 may be provided separately from the information processing apparatus 100.

The image information may be transmitted to a device other than the display unit 140 (for example, an analysis device, a server, or the like connected via a network). In this case, the image information may be used for processing in another device (for example, analysis processing such as detection of a specific cell).

### (Determination of Positive Threshold Value)

Next, a specific determination method for the positive threshold value will be described.

The separation unit 40 (see FIG. 7) can perform the following processing in addition to the color separation processing P1 and P11 described above.

That is, the separation unit 40 can generate a pseudo stained fluorescence spectrum D4 on the basis of the stained fluorescence component image D2 and the fluorescence reference spectrum R1 described above (processing P2 in FIG. 8; S14 in FIG. 9). For example, the separation unit 40 can obtain the pseudo stained fluorescence spectrum D4 as an artificial stained fluorescence spectrum, by multiplying the stained fluorescence component image D2 by the fluorescence reference spectrum R1.

Furthermore, the separation unit 40 can generate a pseudo stained autofluorescence spectrum D5 on the basis of the stained autofluorescence component image D3 and the autofluorescence reference spectrum R2 described above (processing P3 in FIG. 8; S14 in FIG. 9). For example, the separation unit 40 can obtain the pseudo stained autofluorescence spectrum D5 as an artificial stained autofluorescence spectrum, by multiplying the stained autofluorescence component image D3 by the autofluorescence reference spectrum R2.

In a case of using the above-described non-negative matrix factorization (NMF) in the color separation processing P1 of the stained specimen fluorescence spectrum D1, the autofluorescence reference spectrum R2 changes (is corrected) to be optimized to the stained specimen fluorescence spectrum D1 by the NMF. In this case, at a time of generating the pseudo stained autofluorescence spectrum D5, a more accurate pseudo stained autofluorescence spectrum D5 can be obtained by using the autofluorescence reference spectrum R2 after optimization correction.

As described above, in various types of processing performed to determine the positive threshold value, the autofluorescence reference spectrum R2 stored in the storage unit 120 may be used, or the autofluorescence reference spectrum R2 after optimization correction may be used, as necessary. The “autofluorescence reference spectrum R2” mentioned in the following description is a concept that can include not only the autofluorescence reference spectrum R2 stored in the storage unit 120 but also the autofluorescence reference spectrum R2 after optimization correction.

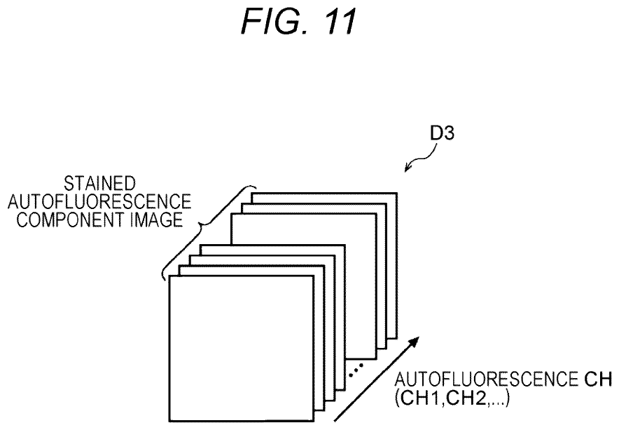

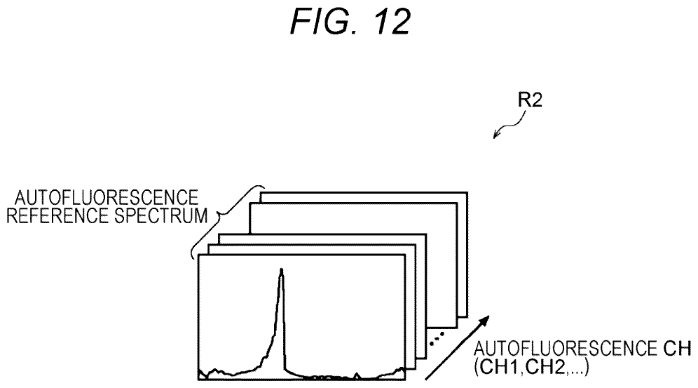

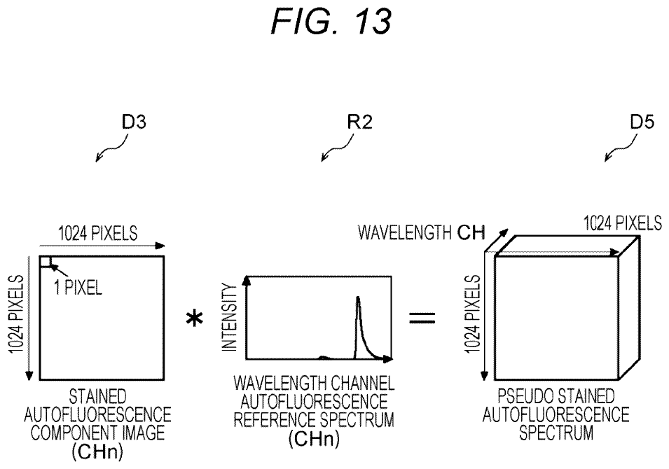

FIG. 11 is a view illustrating a concept of an example of the stained autofluorescence component image D3. FIG. 12 is a view illustrating a concept of an example of the autofluorescence reference spectrum R2. FIG. 13 is a view illustrating a concept of an example of an arithmetic operation of calculating the pseudo stained autofluorescence spectrum D5 from the stained autofluorescence component image D3 and the autofluorescence reference spectrum R2.

The separation unit 40 selects one that is unselected (this is defined as a stained autofluorescence component image of an autofluorescence channel CHn (“n” is a natural number)) from the stained autofluorescence component image D3 (see FIG. 11). Note that, the autofluorescence channel mentioned here may be identification information given to each autofluorescence.

Then, the separation unit 40 generates the pseudo stained autofluorescence spectrum D5, from the stained autofluorescence component image of the selected autofluorescence channel CHn and the autofluorescence reference spectrum corresponding to the selected autofluorescence channel CHn.

The separation unit 40 may generate a stained specific channel luminance image D6 by obtaining a luminance value of spectrum data corresponding to a specific channel in the pseudo stained autofluorescence spectrum D5 (processing P4 in FIG. 8).

Then, the separation unit 40 can generate a pseudo stained specimen fluorescence spectrum D7 on the basis of the pseudo stained fluorescence spectrum D4 and the pseudo stained autofluorescence spectrum D5 (processing P5 in FIG. 8; S15 in FIG. 9). For example, the separation unit 40 can obtain the pseudo stained specimen fluorescence spectrum D7 by adding the pseudo stained fluorescence spectrum D4 and the pseudo stained autofluorescence spectrum D5. The pseudo stained specimen fluorescence spectrum D7 thus generated is an artificial stained specimen fluorescence spectrum.

Then, the separation unit 40 generates a difference stained specimen fluorescence spectrum D8 on the basis of a difference between the stained specimen fluorescence spectrum D1 and the pseudo stained specimen fluorescence spectrum D7 (processing P6 in FIG. 8; S16 in FIG. 9).

Then, the separation unit 40 obtains a norm image of the difference stained specimen fluorescence spectrum D8, which is difference spectrum data of the stained specimen fluorescence spectrum D1 and the pseudo stained specimen fluorescence spectrum D7, as a difference stained norm image D9 (processing P7 in FIG. 8; S17 in FIG. 9). The difference stained norm image D9 is obtained by calculating a Euclidean norm in a wavelength direction (depth direction) of the difference stained specimen fluorescence spectrum D8. As described above, the separation unit 40 (second separation unit 42) generates the difference stained norm image (difference stained norm data) D9, which is norm data of the difference stained specimen fluorescence spectrum D8.

Then, the separation unit 40 can separate the difference stained specimen fluorescence spectrum D8 into a difference stained fluorescence component image D10 containing a fluorescent reagent and a difference stained autofluorescence component image Dl1 containing an autofluorescence component, by using the reference spectra R1 and R2 (processing P8 in FIG. 8; S18 in FIG. 9). Specifically, the separation unit 40 generates the difference stained fluorescence component image D10 and the difference stained autofluorescence component image D11 from the difference stained specimen fluorescence spectrum D8, by performing the same processing as the above-described color separation processing (see P1 in FIG. 8) on the difference stained specimen fluorescence spectrum D8.

As described above, the separation unit 40 can continuously perform the series of processing (P1 to P8) based on the stained specimen fluorescence spectrum D1.

The separation unit 40 can continuously perform the series of processing (P11 to P18) based on the unstained specimen fluorescence spectrum D21 in a similar manner.

That is, the separation unit 40 can generate a pseudo unstained fluorescence spectrum D24 on the basis of the unstained fluorescence component image D22 and the fluorescence reference spectrum R1 described above (processing P12 in FIG. 8; S24 in FIG. 10).

Furthermore, the separation unit 40 can generate a pseudo unstained autofluorescence spectrum D25 on the basis of the unstained autofluorescence component image D23 and the autofluorescence reference spectrum R2 described above (processing P13 in FIG. 8; S24 in FIG. 10).

The separation unit 40 may generate an unstained specific channel luminance image D26 by obtaining a luminance value of spectrum data corresponding to a specific channel in the pseudo unstained autofluorescence spectrum D25 (processing P14 in FIG. 8).

Then, the separation unit 40 can generate a pseudo unstained specimen fluorescence spectrum D27 on the basis of the pseudo unstained fluorescence spectrum D24 and the pseudo unstained autofluorescence spectrum D25 (processing P15 in FIG. 8; S25 in FIG. 10).

Then, the separation unit 40 can generate a difference unstained specimen fluorescence spectrum D28 on the basis of a difference between the unstained specimen fluorescence spectrum D21 and the pseudo unstained specimen fluorescence spectrum D27 (processing P16 in FIG. 8; S26 in FIG. 10).

Then, the separation unit 40 obtains the norm image of the difference unstained specimen fluorescence spectrum D28 as a difference unstained norm image D29 (processing P17 in FIG. 8; S27 in FIG. 10). The difference unstained norm image D29 is obtained by calculating a Euclidean norm in a wavelength direction (depth direction) of the difference unstained specimen fluorescence spectrum D28. As described above, the separation unit 40 (second separation unit 42) generates the difference unstained norm image (difference unstained norm data) D29, which is norm data of the difference unstained specimen fluorescence spectrum D28.

Then, the separation unit 40 can separate the difference unstained specimen fluorescence spectrum D28 into a difference unstained fluorescence component image D30 containing a fluorescent reagent and a difference unstained autofluorescence component image D31 containing an autofluorescence component, by using the reference spectra R1 and R2 (processing P18 in FIG. 8; S28 in FIG. 10). That is, the separation unit 40 generates the difference unstained fluorescence component image D30 and the difference unstained autofluorescence component image D31 from the difference unstained specimen fluorescence spectrum D28, by performing the same processing as the above-described color separation processing (see P11 in FIG. 8) on the difference unstained specimen fluorescence spectrum D28.

### (First Positive Threshold Value Determination Method)

The threshold value determination unit 43 can determine a positive threshold value for the stained fluorescence component image D2, on the basis of the unstained fluorescence component image D22 (see FIG. 8) derived by the separation unit 40 as described above.

According to the present example, the positive threshold value is determined on the basis of the unstained fluorescence component image D22 obtained from the unstained specimen fluorescence spectrum D21 used as a negative control group. Therefore, in the stained fluorescence component image D2, an image section affected by fluorescence caused by the fluorescent reagent 10 can be accurately distinguished from an image section not affected by the fluorescence, and can be specified as a positive cell image.

A specific method for determining the positive threshold value in the present example is not limited.

As an example, the positive threshold value can be determined on the basis of a luminance value of the unstained fluorescence component image D22.

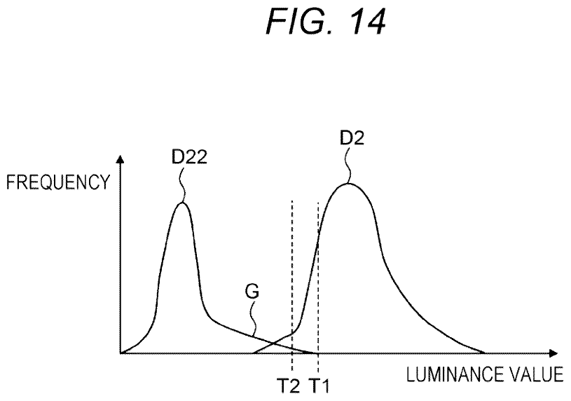

FIG. 14 illustrates an example of a histogram of the stained fluorescence component image D2 and the unstained fluorescence component image D22. In FIG. 14, an X-axis indicates a luminance value, and a Y-axis indicates a frequency.

For example, the threshold value determination unit 43 may determine, as the positive threshold value, a luminance value (see reference sign “T1” in FIG. 14) corresponding to an edge (particularly, a high-luminance value side edge) of the histogram of the unstained fluorescence component image D22.

A way of obtaining the edge of the histogram of the unstained fluorescence component image D22 is not limited.

For example, a maximum luminance value in the unstained fluorescence component image D22 may be determined as the edge of the histogram of the unstained fluorescence component image D22.

Alternatively, an inclination of a gradient of the histogram of the unstained fluorescence component image D22 (see reference sign “G” in FIG. 14) may be obtained, and the edge of the histogram of the unstained specimen fluorescence spectrum D21 may be determined on the basis of the inclination. In this case, a way of determining an “gradient point for determining the inclination” in the histogram of the unstained fluorescence component image D22 is not limited.

For example, the gradient point may be determined on the basis of a frequency of a luminance value of the unstained fluorescence component image D22. Specifically, the gradient point can be determined similarly to a way of determining a “positive threshold value T2” described later.

Alternatively, the threshold value determination unit 43 may determine and use, as the positive threshold value, a luminance value (see reference sign “T2” in FIG. 14) determined on the basis of a frequency of a luminance value of the unstained fluorescence component image D22. For example, a luminance value corresponding to a predetermined area from a low luminance value side or a high luminance value side (for example, 95% area from the low luminance value side) in an area of the histogram of the unstained fluorescence component image D22 may be determined as the positive threshold value. Alternatively, a luminance value corresponding to a predetermined value from the low luminance value side or the high luminance value side (for example, 95% from the low luminance value side) of a distance (distance in the X-axis direction in FIG. 14) between both edges of the histogram of the unstained fluorescence component image D22 may be determined as the positive threshold value.

As described above, according to the present example, the threshold value determination unit 43 can determine the positive threshold value on the basis of only the unstained fluorescence component image D22. Therefore, the threshold value determination unit 43 can determine the positive threshold value without the separation unit 40 performing the above-described processing P2 to P8 and P12 to P18 (see FIG. 8).

Therefore, the separation unit 40 may not perform processing (that is, processing P2 to P8 and processing P12 to P18) that does not contribute to determination of the positive threshold value, among the above-described processing. In this case, a processing load in the separation unit 40 can be reduced, and improvement of an overall processing speed related to calculation of the positive threshold value and reduction of a processing time can be promoted.

### (Second Positive Threshold Value Determination Method)

The threshold value determination unit 43 may determine a final positive threshold value by once deriving a positive threshold value and then correcting the positive threshold value.

In the present example, the threshold value determination unit 43 derives the positive threshold value from the unstained fluorescence component image D22 similarly to the first positive threshold value determination method described above. Thereafter, the threshold value determination unit 43 corrects the positive threshold value on the basis of a spectrum of the difference stained fluorescence component image D10 and a spectrum of the difference unstained fluorescence component image D30.

Although a specific correction method for the positive threshold value is not limited, typically, the positive threshold value can be corrected on the basis of a ratio of the spectrum of the difference unstained fluorescence component image D30 to the spectrum of the difference stained fluorescence component image D10.

For example, a correction value of the positive threshold value can be determined on the basis of a “histogram based on a luminance value and a frequency (see FIG. 14)” of the spectrum. An edge (for example, a high-luminance value side edge) of the histogram of the spectrum of the difference stained fluorescence component image D10 is represented by “E1”. Furthermore, a corresponding edge (for example, a high-luminance value side edge) of the histogram of the spectrum of the difference unstained fluorescence component image D30 is represented by “E2”. In this case, the threshold value determination unit 43 may determine the final positive threshold value by using “E1/E2” as the correction value (correction coefficient) and applying to the positive threshold value (that is, multiplying).

According to the present example, the positive threshold value is corrected by using intermediate data (that is, the difference stained fluorescence component image D10 and the difference unstained fluorescence component image D30) derived from both the stained specimen fluorescence spectrum D1 and the unstained specimen fluorescence spectrum D21.

Therefore, it is possible to stably obtain the positive threshold value with high accuracy as compared with the above-described first positive threshold value determination method in which the positive threshold value is determined on the basis of only intermediate data (that is, the unstained fluorescence component image D22) derived from the unstained specimen fluorescence spectrum D21. As described above, according to the present example, it is possible to correct the positive threshold value so as to compensate for an arithmetic operation error, and to determine a more accurate positive threshold value.

Furthermore, the difference stained fluorescence component image D10 and the difference unstained fluorescence component image D30 used to determine the correction value are intermediate data obtained by arithmetic processing of the stained specimen fluorescence spectrum D1 and the unstained specimen fluorescence spectrum D21.

Therefore, the correction value of the positive threshold value can be calculated without requiring input data other than input data to be used for deriving the stained fluorescence component image D2 and the unstained fluorescence component image D22. Therefore, in a series of arithmetic processing in the separation unit 40, derivation of the stained fluorescence component image D2 and the unstained fluorescence component image D22 and derivation of the difference stained fluorescence component image D10 and the difference unstained fluorescence component image D30 can be performed.

### (Third Positive Threshold Value Determination Method)

Similarly to the above-described second positive threshold value determination method, the threshold value determination unit 43 of the present example also derives a positive threshold value from the unstained fluorescence component image D22, and then corrects the positive threshold value to determine a final positive threshold value.

The threshold value determination unit 43 of the present example corrects the positive threshold value on the basis of the difference stained specimen fluorescence spectrum D8 and the difference unstained specimen fluorescence spectrum D28.

Although a specific correction method for the positive threshold value is not limited, typically, the positive threshold value can be corrected on the basis of a ratio of the difference unstained specimen fluorescence spectrum D28 to the difference stained specimen fluorescence spectrum D8.

For example, similarly to the above-described second positive threshold value determination method, the correction value of the positive threshold value can be determined on the basis of a “histogram based on a luminance value and a frequency (see FIG. 14)” of a spectrum. An edge (for example, a high-luminance value side edge) of the histogram of the difference stained specimen fluorescence spectrum D8 is represented by “E3”. Furthermore, a corresponding edge (for example, a high luminance value side edge) of the histogram of the difference unstained specimen fluorescence spectrum D28 is represented by “E4”. In this case, the threshold value determination unit 43 may determine the final positive threshold value by using “E3/E4” as the correction value (correction coefficient) and applying to the positive threshold value (that is, multiplying).

Also in the present example, the positive threshold value is corrected by using intermediate data (that is, the difference stained specimen fluorescence spectrum D8 and the difference unstained specimen fluorescence spectrum D28) derived from both the stained specimen fluorescence spectrum D1 and the unstained specimen fluorescence spectrum D21.

Therefore, it is possible to stably obtain the positive threshold value with high accuracy, and it is possible to correct the positive threshold value so as to compensate for an arithmetic operation error and to determine a more accurate positive threshold value.

Furthermore, the correction value of the positive threshold value can be calculated without requiring input data other than input data to be used for deriving the stained fluorescence component image D2 and the unstained fluorescence component image D22.

### (Fourth Positive Threshold Value Determination Method)

The threshold value determination unit 43 of the present example corrects the unstained fluorescence component image D22 before deriving a positive threshold value from the unstained fluorescence component image D22. That is, the threshold value determination unit 43 derives the positive threshold value from the corrected unstained fluorescence component image D22.

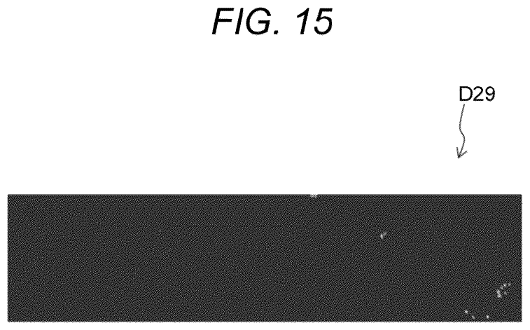

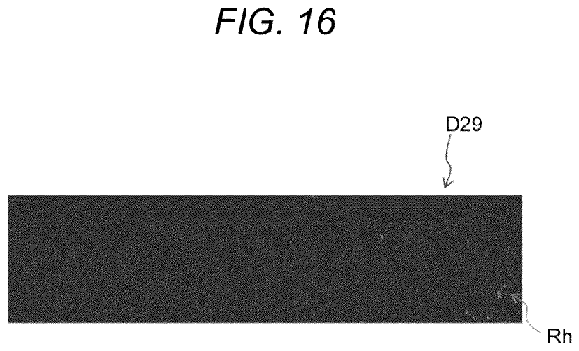

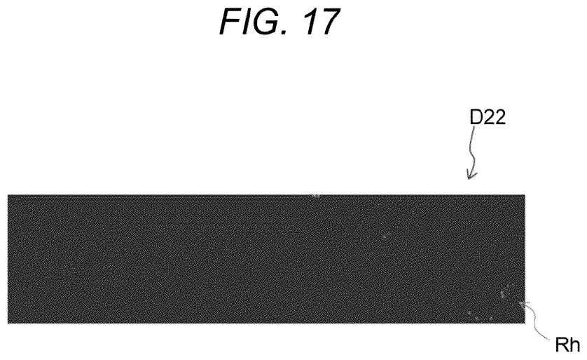

FIG. 15 is a view illustrating an example of the difference unstained norm image D29. FIG. 16 is a view illustrating an example of a region indicating an outlier (hereinafter, also referred to as “outlier region Rh”) in the difference unstained norm image D29. FIG. 17 is a view illustrating an example of the corresponding outlier region Rh in the unstained fluorescence component image D22. FIGS. 15 to 17 are images illustrating luminance.

As illustrated in FIG. 15, the difference unstained norm image D29 may sparsely include a region having a significantly large luminance value (that is, a significantly bright region). As described above, for example, in a pathological specimen, generation of the “region showing a significantly large luminance value” existing sparsely as a space (pixel) can be caused by a tissue (for example, a red blood cell) inherently exhibiting strong autofluorescence.

The luminance value indicated by such a tissue exhibiting strong autofluorescence constitutes an error value (outlier) that may suddenly occur in the fluorescence spectrum, and may inhibit determination of an appropriate positive threshold value. In particular, for example, in a case where an image spectrum obtained by imaging a tissue specimen having a small number of red blood cells is set as a determination target, a luminance value caused by the red blood cells tends to be larger than luminance values of other regions. As a result, an influence of an error value caused by the red blood cells on the determination of the positive threshold value tends to increase.

Note that optimization of the autofluorescence reference spectrum R2 by non-negative matrix factorization (NMF) described above targets the entire image due to its characteristics. Therefore, it is practically difficult to apply NMF specialized for reducing or eliminating local errors caused by tissues exhibiting strong autofluorescence.

Therefore, the threshold value determination unit 43 of the present example analyzes the difference unstained norm image D29 to acquire outlier data.

A specific method for acquiring the outlier data is not limited, but the outlier data can be acquired typically by the following technique.

For example, the threshold value determination unit 43 may determine the outlier in the difference unstained norm image D29 on the basis of an average value of pixel luminance values of the difference unstained norm image D29. As an example, a luminance value separated from the average value of the pixel luminance values of the difference unstained norm image D29 by 3o (3 sigma) or more may be determined as the outlier. Here, “o” indicates standard deviation of the pixel luminance value of the difference unstained norm image D29. In the present example, robustness may be inferior to an “example of determining an outlier on the basis of a median value” exemplified below.

Furthermore, the threshold value determination unit 43 may determine the outlier in the difference unstained norm image D29 on the basis of a median value of pixel luminance values of the difference unstained norm image D29. As an example, a luminance value separated from the median value of the pixel luminance values of the difference unstained norm image D29 by more than three times of median absolute deviation (MAD) may be determined as the outlier.

Furthermore, the threshold value determination unit 43 may determine the outlier in the difference unstained norm image D29 on the basis of a quantile of pixel luminance values of the difference unstained norm image D29. As an example, a pixel luminance value exceeding 1.5 times a quartile range may be determined as the outlier, to the top from a top quartile (75%) of the pixel luminance values of the difference unstained norm image D29.

The threshold value determination unit 43 corrects the unstained fluorescence component image D22 on the basis of the outlier data determined as described above. That is, the threshold value determination unit 43 corrects the unstained fluorescence component image D22 so as to reduce the influence of the outlier in the unstained fluorescence component image D22.

A specific correction method for the unstained fluorescence component image D22 based on the outlier data is not limited, but is performed as follows, for example.

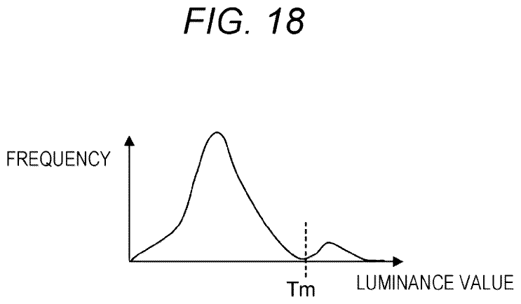

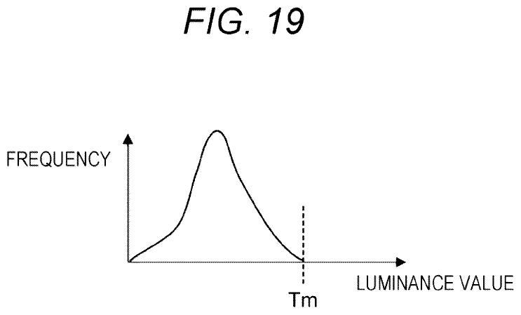

FIG. 18 illustrates an example of a histogram of the unstained fluorescence component image D22. FIG. 19 illustrates an example of a histogram of the unstained fluorescence component image D22 after being corrected on the basis of the outlier data. In FIGS. 18 and 19, an X-axis indicates a luminance value, and a Y-axis indicates a frequency.

For example, the threshold value determination unit 43 determines a mask threshold value Tm (for example, “mask threshold value Tm=outlier) on the basis of the outlier obtained from the difference unstained norm image D29 as described above. Then, the threshold value determination unit 43 may correct the unstained fluorescence component image D22 by reducing a luminance value of a pixel indicating a luminance value larger than the mask threshold value Tm.

In the examples illustrated in FIGS. 18 and 19, the pixel indicating the luminance value larger than the mask threshold value Tm in the unstained fluorescence component image D22 is assigned with “luminance value=0 (zero)” by the correction method. As a result, a graph region indicating a significantly large luminance value in FIG. 18 disappears after the correction as illustrated in FIG. 19. That is, the unstained fluorescence component image D22 is corrected such that a graph region indicating a luminance value larger than the mask threshold value Tm in FIG. 18 is shifted to a graph region indicating “luminance value=0” in FIG. 19.

The threshold value determination unit 43 determines the positive threshold value on the basis of the unstained fluorescence component image D22 corrected in this manner. A specific method for determining the positive threshold value based on the corrected unstained fluorescence component image D22 is not limited. For example, in a case of performing correction of assigning “luminance value=0 (zero)” to the pixel indicating the luminance value larger than the mask threshold value Tm in the unstained fluorescence component image D22, the positive threshold value may be determined on the basis of a maximum luminance value indicated by the corrected unstained fluorescence component image D22. That is, the maximum luminance value indicated by the corrected unstained fluorescence component image D22 may be determined as the positive threshold value.

Furthermore, the positive threshold value determination method of the present example can also be applied to the first to third positive threshold value determination methods described above.

According to the present example, it is possible to stably obtain a highly accurate positive threshold value while suppressing the influence of the outlier.

Furthermore, the correction value of the positive threshold value can be calculated without requiring input data other than input data to be used for deriving the stained fluorescence component image D2 and the unstained fluorescence component image D22.

Furthermore, according to the present example, the threshold value determination unit 43 can determine the positive threshold value on the basis of the unstained fluorescence component image D22 and the difference unstained norm image D29. Therefore, since the threshold value determination unit 43 can determine the positive threshold value without the separation unit 40 performing the above-described processing P2 to P8 (see FIG. 8), a processing load in the separation unit 40 can be reduced.

### (Fifth Positive Threshold Value Determination Method)

In the above-described first to fourth positive threshold value determination methods, the positive threshold value for the stained fluorescence component image D2 is derived on the basis of the image spectrum data (particularly, the unstained fluorescence component image D22) obtained from the unstained specimen fluorescence spectrum D21.

Whereas, it is also possible to derive the positive threshold value for the stained fluorescence component image D2 on the basis of the image spectrum data obtained from the stained specimen fluorescence spectrum D1. For example, the threshold value determination unit 43 can derive and determine the positive threshold value, on the basis of the image spectrum data that is derived on the basis of the stained fluorescence component image D2 and the fluorescence reference spectrum R1.

In the positive threshold value determination method of the present example, the positive threshold value for the stained fluorescence component image D2 is determined on the basis of the difference stained fluorescence component image D10 (see FIG. 8).

For example, the threshold value determination unit 43 may determine the positive threshold value on the basis of a luminance value corresponding to an edge of a histogram of “luminance value (X-axis)−frequency (Y-axis)” of the difference stained fluorescence component image D10.

Here, a way of obtaining the edge of the histogram of the difference stained fluorescence component image D10 is not limited. For example, the threshold value determination unit 43 can determine the edge of the histogram of the difference stained fluorescence component image D10 by a method similar to the way of determining the edge of the histogram of the unstained fluorescence component image D22 described above (see FIG. 14).

Alternatively, the threshold value determination unit 43 may determine, as the positive threshold value, a luminance value that is determined on the basis of a frequency of a luminance value of the difference stained fluorescence component image D10. For example, a luminance value corresponding to a predetermined area from a low luminance value side or a high luminance value side (for example, 95% area from the low luminance value side) in an area of the histogram of the difference stained fluorescence component image D10 may be determined as the positive threshold value. Alternatively, a luminance value corresponding to a predetermined value from a low luminance value side or a high luminance value side (for example, 95% from the low luminance value side) of a distance between both edges of the histogram of the difference stained fluorescence component image D10 may be determined as the positive threshold value.

According to the present example, the threshold value determination unit 43 can determine the positive threshold value for the stained fluorescence component image D2 on the basis of the stained specimen fluorescence spectrum D1, the fluorescence reference spectrum R1, and the autofluorescence reference spectrum R2.

Therefore, data derived from the unstained specimen fluorescence spectrum D21 and the unstained specimen fluorescence spectrum D21 is not required in order to determine the positive threshold value for the stained fluorescence component image D2. That is, according to the present example, the separation unit 40 can determine the positive threshold value without performing the above-described processing P11 to P18 (see FIG. 8).

Therefore, the separation unit 40 may not perform processing (that is, the processing P11 to P18) that does not contribute to determination of the positive threshold value, among the above-described processing. Furthermore, since the unstained specimen fluorescence spectrum D21 is unnecessary for determining the positive threshold value, it is not necessary to prepare the unstained specimen fluorescence spectrum D21 in the first place.

Furthermore, in the present example, the difference stained fluorescence component image D10 used for determining the positive threshold value corresponds to a calculation error in the color separation processing P1 of the stained specimen fluorescence spectrum D1. Therefore, according to the positive threshold value determination method of the present example, it is possible to determine a positive threshold value effective for reducing an influence of the calculation error.

### Display Example

Next, with reference to FIGS. 20 to 22, a display example of the image information on the display unit 140 will be described.

FIG. 20 illustrates an example of display of image information on the display unit 140.

The image information illustrated in FIG. 20 includes specimen image information J1 and presentation information J2.

The specimen image information J1 is information about an image based on the stained specimen fluorescence spectrum D1, and is typically the stained fluorescence component image D2 obtained by performing the color separation processing on the stained specimen fluorescence spectrum D1. However, the specimen image information J1 may be an image other than the stained fluorescence component image D2, and is not particularly limited. For example, the specimen image information J1 may be a stained specimen image corresponding to the stained specimen fluorescence spectrum D1, or may be another image that is generated on the basis of the stained fluorescence component image D2 or the stained specimen image.

The stained specimen image mentioned here may be, for example, an image acquired by capturing an image of the fluorescent-stained specimen 30 with an imaging device. An image acquired by capturing an image of the fluorescent-unstained specimen with the imaging device is referred to as an unstained specimen image.

The specimen image information J1 displayed on the display unit 140 may be an image corresponding to the entire range of the fluorescent-stained specimen 30 (particularly, an image-capturing target range) or an image corresponding to a partial range of the fluorescent-stained specimen 30.

In a case of displaying only a partial range of the fluorescent-stained specimen 30 on the display unit 140 as the specimen image information J1, it is preferable to display a range (for example, a range including a positive cell image K2) including a cell image (hereinafter also referred to as “labeled cell image”) labeled with the fluorescent reagent 10, on the display unit 140.

The labeled cell image is classified into a non-positive cell image K1 determined as non-positive on the basis of the positive threshold value, and the positive cell image K2 determined as positive on the basis of the positive threshold value. As an example, in the stained fluorescence component image D2, an image section (particularly, a labeled cell image) indicating a luminance value equal to or more than the positive threshold value can be classified as the positive cell image K2, and an image section (particularly, a labeled cell image) indicating a luminance value smaller than the positive threshold value can be classified as the non-positive cell image K1.

The classification of the non-positive cell image K1 and the positive cell image K2 may be performed, for example, by the image generation unit 133 (see FIGS. 1 and 7), or may be performed by any device such as the analysis unit 47.

In the example illustrated in FIG. 20, each labeled cell image displayed on the display unit 140 is emphasized by a cell image position emphasis mark M1. However, a specific display mode (for example, a color, a thickness, a pattern, and/or a shape) of the cell image position emphasis mark M1 is changed between the non-positive cell image K1 and the positive cell image K2. As a result, the user who looks at the specimen image information J1 displayed on the display unit 140 can intuitively recognize the non-positive cell image K1 and the positive cell image K2 in the specimen image information J1.

Whereas, the presentation information J2 displayed on the display unit 140 includes threshold value information indicating the positive threshold value.

In the example illustrated in FIG. 20, the positive threshold value is indicated by a gauge (indicator). That is, the positive threshold value used for the classification of the non-positive cell image K1 and the positive cell image K2 is indicated by a positive threshold mark Q. The indicator of the presentation information J2 in FIG. 20 is represented by 16 bits (0 to 65535), and a lower part of the indicator (that is, as the value is larger) indicates the positive threshold value corresponding to a high luminance value.

The user can appropriately adjust the positive threshold value to be used for the classification of the non-positive cell image K1 and the positive cell image K2, by moving the positive threshold mark Q along the indicator via the operation unit 160 (see FIG. 1).

In this case, the control unit 150 (see FIG. 1) controls the image generation unit 133 and/or the display unit 140 so as to adjust the position of the positive threshold mark Q displayed on the display unit 140, in accordance with an adjustment instruction signal input by the user via the operation unit 160.

Whereas, the image generation unit 133 acquires the positive threshold value after adjustment according to the adjustment instruction signal input via the operation unit 160 from, for example, the control unit 150. Then, the image generation unit 133 reclassifies the non-positive cell image K1 and the positive cell image K2 in accordance with the positive threshold value after adjustment. Then, the image generation unit 133 generates image information (the specimen image information J1 and the presentation information J2) according to a reclassification result and the positive threshold value after adjustment, and transmits the image information to the display unit 140.

As a result, the image information generated on the basis of the positive threshold value after adjustment by the user is displayed on the display unit 140.

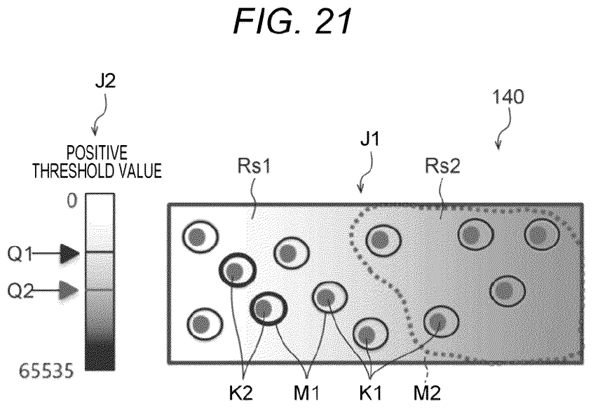

FIG. 21 illustrates another example of display of image information on the display unit 140. In FIG. 21, the same or corresponding elements as those illustrated in FIG. 20 are denoted by the same reference numerals, and a detailed description thereof will be omitted.

In the example illustrated in FIG. 20 described above, the non-positive cell image K1 and the positive cell image K2 are classified by using the common positive threshold value over the entire specimen image information J1.

Whereas, in the example illustrated in FIG. 21, a positive threshold value is determined for each of a plurality of observation regions (small regions) Rs1 and Rs2 defined by sectioning the stained fluorescence component image D2 displayed in the specimen image information J1.

The threshold value determination unit 43 (see FIG. 7) determines the positive threshold value for each of the plurality of observation regions Rs1 and Rs2 determined by sectioning the stained fluorescence component image D2.

In a wide visual field tissue image such as a whole slide imaging (WSI), a unique feature may appear in each of a plurality of sectioned regions (for example, a region with high background noise and a region with low background noise). Therefore, there is a need to set the positive threshold value for each sectioned region of the tissue image for analysis.

For example, the threshold value determination unit 43 may acquire information indicating a noise component included in the stained specimen fluorescence spectrum D1, by analyzing the stained specimen fluorescence spectrum D1, the stained fluorescence component image D2, and/or the stained autofluorescence component image D3. In this case, the threshold value determination unit 43 can define the plurality of observation regions Rs1 and Rs2 by sectioning the stained fluorescence component image D2 in accordance with the acquired noise component. As a result, it is possible to section the image of the specimen image information J1 in accordance with magnitude of background noise, and automatically set the plurality of observation regions Rs1 and Rs2.

In the example illustrated in FIG. 21, a second observation region Rs2 indicating the relatively large background noise is surrounded by an observation region emphasis mark M2. A region outside the observation region emphasis mark M2 is a first observation region Rs1 indicating relatively small background noise.

Note that a user interface that allows the user to adjust the threshold value for each freely determined region may be required. Therefore, the user may designate the plurality of observation regions Rs1 and Rs2 on the user interface, and the positive threshold value may be set to each of the plurality of designated observation regions Rs1 and Rs2.

That is, the threshold value determination unit 43 may determine the positive threshold value for each of the plurality of observation regions Rs1 and Rs2 defined by the user.

A method for designating the plurality of observation regions Rs1 and Rs2 by the user is not limited. For example, the user may operate the operation unit 160 (see FIG. 1) to designate the plurality of observation regions Rs1 and Rs2 in any manner while viewing the specimen image information J1 (the stained fluorescence component image D2) on the display unit 140.

The control unit 150 can acquire information regarding the plurality of observation regions Rs1 and Rs2 designated by the user from the operation unit 160, and directly or indirectly provide the information to the processing unit 130. Then, the processing unit 130 (for example, the separation processing unit 132 and the image generation unit 133) may determine the positive threshold value and generate the image information, on the basis of the information regarding the plurality of observation regions Rs1 and Rs2. As a result, the image information based on the plurality of observation regions Rs1 and Rs2 designated by the user can be displayed on the display unit 140.

Also in the example illustrated in FIG. 21, the user can adjust the positive threshold value by moving positive threshold marks Q1 and Q2 via the operation unit 160.

The positive threshold mark may be provided for each observation region. A first positive threshold mark Q1 illustrated in FIG. 21 is provided for the first observation region Rs1, and a second positive threshold mark Q2 is provided for the second observation region Rs2.

Similarly to the positive threshold mark Q illustrated in FIG. 20, the user can change and adjust the positive threshold value assigned to each of the first observation region Rs1 and the second observation region Rs2, by moving each of the first positive threshold mark Q1 and the second positive threshold mark Q2 via the operation unit 160.

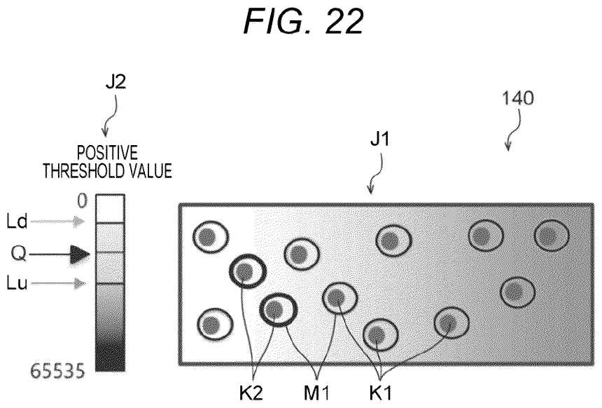

FIG. 22 illustrates another example of display of image information on the display unit 140. In FIG. 22, the same or corresponding elements as those illustrated in FIGS. 20 and 21 are denoted by the same reference numerals, and a detailed description thereof will be omitted.

In the example illustrated in FIG. 22, the presentation information J2 displayed on the display unit 140 includes correctable range information indicating a correctable range of the positive threshold value, in addition to the threshold value information indicating the positive threshold value.

The presentation information J2 illustrated in FIG. 22 includes display of a correctable upper limit value Lu and a correctable lower limit value Ld, in addition to the positive threshold mark Q.

The display of the correctable upper limit value Lu and the correctable lower limit value Ld indicates an upper limit value and a lower limit value of the correctable range of the positive threshold value, respectively. Therefore, in the indicator of the presentation information J2, the positive threshold mark Q basically indicates somewhere in a range defined by the correctable upper limit value Lu and the correctable lower limit value Ld.

The correctable range of the positive threshold value determined by the correctable upper limit value Lu and the correctable lower limit value Ld can be displayed in any form. For example, an inside and an outside of the correctable range of the positive threshold value may be displayed in mutually different colors or patterns. Furthermore, in the indicator of the presentation information J2, display of a line or the like indicating the correctable upper limit value Lu and the correctable lower limit value Ld may be shown.

The user can adjust the positive threshold value by moving the positive threshold mark Q via the operation unit 160, while using the correctable range of the positive threshold value indicated in the presentation information J2 as a guide.

The correctable range of the positive threshold value (that is, the correctable upper limit value Lu and the correctable lower limit value Ld) can be determined by the threshold value determination unit 43 (see FIG. 7). The information indicating the correctable range determined by the threshold value determination unit 43 is output from the separation output unit 44, and transmitted to the analysis unit 47, the image generation unit 133, and the like.

Note that a specific method for determining the correctable range of the positive threshold value is not limited.

As an example, the correctable range of the positive threshold value may be determined on the basis of positive threshold values determined individually by a plurality of positive threshold value determination methods. For example, the correctable lower limit value Ld may be determined on the basis of a minimum value among positive threshold values determined by the first to fifth positive threshold value determination methods described above, and the correctable upper limit value Lu may be determined on the basis of a maximum value among the positive threshold values.

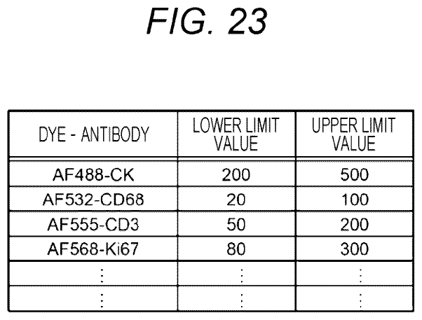

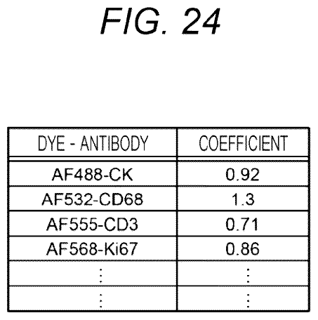

Alternatively, the correctable range of the positive threshold value may be determined on the basis of a correction value (for example, a predetermined correction value as described in a first modification (FIGS. 23 and 24) to be described later) assigned to the positive threshold value. In this case, the threshold value determination unit 43 may acquire data in the correctable range of the positive threshold value, for example, by reading the data from a storage unit (for example, the database 200 or the information storage unit 121).

The correctable range of the positive threshold value determined in this manner is displayed on the display unit 140 as described above, but may be transmitted to another device and used for processing of analysis software or the like.

Note that FIGS. 20 to 22 described above merely illustrate display examples in the display unit 140, and the display unit 140 may display the image information in any other form.

As described above, according to the present embodiment (the information processing apparatus and the information processing method), the positive threshold value used in analysis of the stained fluorescence component image D2 can be determined on the basis of the specimen fluorescence spectrum (the stained specimen fluorescence spectrum D1 and/or the unstained specimen fluorescence spectrum D21).

By using the positive threshold value determined without intervention of subjectivity of the user in this manner, it is possible to prevent an analysis result of the stained fluorescence component image D2 from varying among users and stably obtain a highly accurate analysis result. Furthermore, even if the user is not a specialized operator skilled in analysis, a highly accurate analysis result can be obtained.

Furthermore, since the positive threshold value can be automatically determined from the stained specimen fluorescence spectrum D1 and/or the unstained specimen fluorescence spectrum D21, adjustment work for analysis can be made efficient. As a result, it is possible to reduce time and effort of the user for analysis processing and an adjustment work time of the user, and it is possible to promote speeding up and improvement in accuracy of result calculation when performing clinical research and diagnosis.

Furthermore, the determined positive threshold value can be automatically displayed on the display unit 140. The user can check the specimen image information J1 (particularly, the non-positive cell image K1 and the positive cell image K2) displayed on the display unit 140 while checking the positive threshold value, by viewing the presentation information J2 displayed on the display unit 140.

Furthermore, in the above-described embodiment, since the positive threshold value can be determined regardless of phenotype of each stained specimen fluorescence spectrum D1 (corresponding specimen image information J1), versatility of application is high without depending on the characteristics of the XY space of the stained specimen fluorescence spectrum D1.

### First Modification

The threshold value determination unit 43 may correct the positive threshold value on the basis of a predetermined correction value.

A correction method for the positive threshold value by using the predetermined correction value is not limited. Typically, a limit value (that is, an upper limit value and/or a lower limit value) that defines a range of a numerical value that can be taken by the positive threshold value can be determined in advance as the correction value. Furthermore, a correction coefficient to be used for multiplication with respect to the positive threshold value can be determined in advance as the correction value.

Such a correction value can be determined, for example, in accordance with a fluorescent reagent, or can be determined in accordance with a combination of a fluorescent reagent and a labeling target to be labeled with the fluorescent reagent.

The labeling target mentioned here refers to a substance that can be labeled with the fluorescent reagent (for example, a substance that reacts with the fluorescent reagent to emit fluorescence). Typically, a target such as an antibody may be included in the labeling target, but other cells and tissues (for example, organs, cancer cells, and other cells/tissues) may also be included in the labeling target mentioned here.

The database 200 and the storage unit 120 (for example, the information storage unit 121) illustrated in FIG. 1 can be used as a correction data storage unit that stores a correction value that can be used for correcting the positive threshold value. For example, the database 200 can store in advance the reagent identification information 11 and a corresponding correction value in association with each other, for each of the plurality of fluorescent reagents that can be used. Furthermore, the database 200 can store labeling target identification information, the reagent identification information 11, and the correction value in association with each other, for each of the plurality of fluorescent reagents that can be used and each of the plurality of targets that can be labeled.

Here, the labeling target identification information is information for identifying the labeling target. In the present example, the specimen identification information 21 includes the labeling target identification information, and the labeling target identification information is associated with the specimen 20.

One fluorescent reagent may be used for two or more labeling targets in some cases. That is, there is a case where the fluorescent reagent is common but labeling targets are different, and the database 200 may store different correction values in association with each of such cases.

FIGS. 23 and 24 illustrate examples of correction values stored in a correction data storage unit (for example, the database 200).

In the example illustrated in FIG. 23, a corresponding “lower limit value” and “upper limit value” associated with each of combinations of “dye” and “antibody (labeling target)” are stored as the correction values in the correction data storage unit. Whereas, in the example illustrated in FIG. 24, a corresponding “coefficient” associated with each of combinations of “dye” and “antibody (labeling target)” are stored in the correction data storage unit as the correction value.

In the correction data storage unit, the correction values are stored in any form such as a lookup table.

The information acquisition unit 111 (see FIG. 1) can read and acquire the corresponding correction value from the database 200, on the basis of the reagent identification information 11 associated with the fluorescent reagent 10 used for the fluorescent-stained specimen 30. Alternatively, the information acquisition unit 111 can read and acquire the corresponding correction value from the database 200, on the basis of the reagent identification information 11 and the specimen identification information 21 (particularly, the labeling target identification information) associated with the fluorescent reagent 10 and the specimen 20 used for the fluorescent-stained specimen 30.

Then, the information acquisition unit 111 stores the correction value read from the database 200 into the information storage unit 121.

The correction value stored in the information storage unit 121 is directly or indirectly acquired by the separation processing unit 132 (the threshold value determination unit 43 (see FIG. 7)), and is used for correction of the positive threshold value in the threshold value determination unit 43 (see FIG. 7). As described above, the threshold value determination unit 43 can acquire the correction value from the correction data storage unit that stores the reagent identification information and the correction value in association with each other, on the basis of the reagent identification information 11 via the acquisition unit 110 and the storage unit 120. Similarly, the threshold value determination unit 43 can acquire the correction value from the correction data storage unit that stores the labeling target identification information, the reagent identification information, and the correction value in association with each other, on the basis of the labeling target identification information and the reagent identification information 11 via the acquisition unit 110 and the storage unit 120.

For example, in the example illustrated in FIG. 23, a case is assumed in which the positive threshold value derived by the threshold value determination unit 43 is “600” in a case where the fluorescent-stained specimen 30 is originating from “AF488-CK”.

In this case, as is apparent from FIG. 23, the positive threshold value exceeds an upper limit value (that is, “500”) assigned to “AF488-CK”. Therefore, the threshold value determination unit 43 corrects the positive threshold value and changes the positive threshold value to “500”.

The separation output unit 44 outputs the positive threshold value corrected by the threshold value determination unit 43, and a post-stage device (for example, the analysis unit 47 or the image generation unit 133 in FIG. 7) uses the corrected positive threshold value.

By setting a limit value of the positive threshold value in this manner, it is possible to prevent an unexpected extremely large value or extremely small value from being set as the positive threshold value.

Whereas, in the example illustrated in FIG. 24, a case is assumed in which the positive threshold value derived by the threshold value determination unit 43 tends to be derived higher than the original value in a case where the fluorescent-stained specimen 30 is originating from “AF488-CK”.

In this case, the threshold value determination unit 43 can suppress an influence of such a tendency by multiplying the positive threshold value by an appropriate coefficient smaller than 1 (“0.92” in the example illustrated in FIG. 24) to perform correction.

Note that, in a case where the positive threshold value derived by the threshold value determination unit 43 tends to be derived smaller than the original value, an appropriate coefficient larger than 1 may be used as the correction value (see “AF532-CD68” in FIG. 24).

As described above, in the present example, a correction value corresponding to each reagent that can be used and/or each labeling target that can be a detection target is stored in advance in the correction data storage unit as database information. The threshold value determination unit 43 can determine the final positive threshold value by acquiring the correction value corresponding to the actual fluorescent-stained specimen 30 from the correction values stored in advance in the correction data storage unit, and applying the correction value to the positive threshold value.

Therefore, the positive threshold value is corrected in accordance with the “fluorescent reagent” or “combination of the fluorescent reagent and the labeling target” to be used for the fluorescent-stained specimen 30. As a result, even in a case where the threshold value determination unit 43 erroneously derives a value largely deviated from the original value as the positive threshold value for some reason, it is possible to prevent such an erroneous value from being used as it is as the positive threshold value.

Note that the “correction value used to correct the positive threshold value” stored in the correction data storage unit (for example, the database 200) may be appropriately updated. For example, the user may update the correction value stored in the correction data storage unit at an appropriate timing (for example, periodically).

### Application Example

The information processing system described above may include an imaging device (including a scanner or the like, for example) that acquires a fluorescence spectrum, and an information processing apparatus that performs processing by using the fluorescence spectrum. In this case, the fluorescence signal acquisition unit 112 illustrated in FIG. 1 can be implemented by the imaging device, and other configurations can be implemented by the information processing apparatus. Furthermore, the information processing system described above may include an imaging device that acquires a fluorescence spectrum, and software to be used for processing using the fluorescence spectrum. In other words, a physical configuration (for example, a memory, a processor, or the like) for storing and executing the software may not be provided in the information processing system. In this case, the fluorescence signal acquisition unit 112 illustrated in FIG. 1 can be implemented by the imaging device, and other configurations can be implemented by the information processing apparatus on which the software is executed. Then, the software is provided to the information processing apparatus from, for example, a website, a cloud server, or the like via a network, or provided to the information processing apparatus via any storage medium (for example, a disk or the like). Furthermore, the information processing apparatus on which the software is executed may be various servers (for example, a cloud server or the like), a general-purpose computer, a PC, a tablet PC, or the like. Note that a method by which the software is provided to the information processing apparatus and a type of the information processing apparatus are not limited to those described above. Furthermore, it should be noted that the configuration of the above-described information processing system is not necessarily limited to the above-described configuration, and a configuration that can be conceived by a person skilled in the art can be applied on the basis of a technical level at the time of use.

### (Application Example to Microscope System)

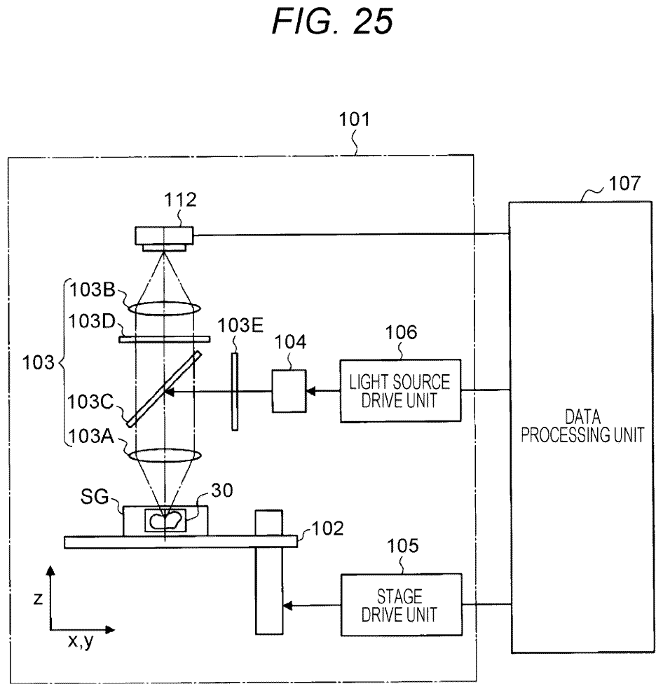

The information processing system described above may be implemented as, for example, a microscope system. With reference to FIG. 25, a configuration example of a microscope system that implements the above-described information processing system will be described.

The microscope system illustrated in FIG. 25 includes a microscope 101 and a data processing unit 107. FIG. 25 illustrates an example of a measurement system capable of capturing an image of a wide visual field region of the fluorescent-stained specimen 30 and a fluorescent-unstained specimen, and the measurement system is also applicable to, for example, WSI.

The microscope 101 includes a stage 102, an optical system 103, a light source 104, a stage drive unit 105, a light source drive unit 106, and a fluorescence signal acquisition unit 112.

The stage 102 has a placement surface on which the fluorescent-stained specimen 30 and the fluorescent-unstained specimen can be placed, and is provided to be movable in a horizontal direction (an x-y plane direction) parallel to the placement surface and a vertical direction (a z-axis direction), by driving of the stage drive unit 105. The fluorescent-stained specimen 30 has a thickness of, for example, several μm to several tens μm in the Z-axis direction, and is fixed by a predetermined technique while being sandwiched between a slide glass SG and a cover glass (not illustrated).

The optical system 103 is disposed above the stage 102. The optical system 103 includes an objective lens 103A, an imaging lens 103B, a dichroic mirror 103C, an emission filter 103D, and an excitation filter 103E. The light source 104 is, for example, a light bulb such as a mercury lamp, a light emitting diode (LED), or the like, and emits light by driving of the light source drive unit 106. The light emitted from the light source 104 is guided to the fluorescent-stained specimen 30 or the fluorescent-unstained specimen on the placement surface of the stage 102, via the optical system 103.

In a case of obtaining fluorescence images of the fluorescent-stained specimen 30 and the fluorescent-unstained specimen, the excitation filter 103E generates excitation light by transmitting only light having an excitation wavelength for exciting the fluorescent dye among light emitted from the light source 104. The dichroic mirror 103C reflects the excitation light transmitted through the excitation filter 103E and incident thereon, and guides the excitation light to the objective lens 103A. The objective lens 103A condenses the excitation light on the fluorescent-stained specimen 30. The objective lens 103A and the imaging lens 103B magnify the image of the fluorescent-stained specimen 30 to a predetermined magnification, and form the magnified image on the imaging surface of the fluorescence signal acquisition unit 112.

When the fluorescent-stained specimen 30 is irradiated with excitation light, a stain (fluorescent reagent 10) and an autofluorescence component bound to each tissue of the fluorescent-stained specimen 30 emit fluorescence. This fluorescence is transmitted through the dichroic mirror 103C via the objective lens 103A, and reaches the imaging lens 103B via the emission filter 103D. The emission filter 103D absorbs a part of the light enlarged by the objective lens 103A and transmitted through the excitation filter 103E, and transmits only a part of color light. As described above, an image of the color light in which the external light is lost is enlarged by the imaging lens 103B, and formed on the fluorescence signal acquisition unit 112.

Note that a spectroscope (not illustrated) may be provided instead of the imaging lens 103B illustrated in FIG. 25. The spectroscope can be configured using one or more prisms, lenses, and the like, and disperses fluorescence from the fluorescent-stained specimen 30 or the fluorescent-unstained specimen in a predetermined direction. In this case, the fluorescence signal acquisition unit 112 is configured as a photodetector that detects light intensity for each wavelength of fluorescence dispersed by the spectroscope, and inputs a detected fluorescence signal to the data processing unit 107.

The data processing unit 107 drives the light source 104 via the light source drive unit 106, acquires fluorescence spectra/fluorescence images of the fluorescent-stained specimen 30 and the fluorescent-unstained specimen by using the fluorescence signal acquisition unit 112, and performs various types of processing by using the acquired fluorescence spectra/fluorescence images. More specifically, the data processing unit 107 can function as some or all of the information acquisition unit 111, the storage unit 120, the processing unit 130, the display unit 140, the control unit 150, the operation unit 160, or the database 200 of the information processing apparatus 100 illustrated in FIG. 1. Furthermore, the data processing unit 107 can include the analysis unit 47 (see FIG. 7) that performs analysis on the basis of a positive threshold value. For example, by functioning as the control unit 150 of the information processing apparatus 100, the data processing unit 107 controls driving of the stage drive unit 105 and the light source drive unit 106, and controls acquisition of a spectrum by the fluorescence signal acquisition unit 112. Furthermore, by functioning as the processing unit 130 of the information processing apparatus 100, the data processing unit 107 generates image spectrum data, calculates a positive threshold value, performs analysis, and generates image information.

As described above, in the microscope system illustrated in FIG. 25, at least the light source 104, the excitation filter 103E, the dichroic mirror 103C, and the objective lens 103A serve as a light irradiation unit that emits excitation light for exciting the fluorescent reagent 10. Furthermore, the fluorescence signal acquisition unit 112 serves as an imaging device that images a specimen (the fluorescent-stained specimen 30 or the fluorescent-unstained specimen) being irradiated with excitation light to acquire a specimen fluorescence spectrum. Furthermore, the data processing unit 107 serves as an information processing apparatus that analyzes the specimen fluorescence spectrum.

Note that the above-described apparatus described with reference to FIG. 25 is merely an example, and the measurement system according to the above-described embodiment and modifications is not limited to the example illustrated in FIG. 25. For example, the microscope system may not necessarily include all of the configurations illustrated in FIG. 25, or may include a configuration not illustrated in FIG. 25.

The above-described embodiment and modifications can be implemented using a measurement system capable of acquiring image data (hereinafter referred to as “wide visual field image data”) with a sufficient resolution for the entire image-capturing target region or a necessary region (hereinafter also referred to as “region of interest”) in the image-capturing target region. For example, the above-described embodiment and modifications can be implemented using a measurement system capable of capturing an image of the entire image-capturing target region or a necessary region (hereinafter referred to as “region of interest”) of the image-capturing target region at one time, or a measurement system that acquires an image of the entire image-capturing region or the region of interest by line scanning.

In the microscope system illustrated in FIG. 25, in a case where the entire image-capturing region is WSI exceeding a region where image data can be acquired in one time of image-capturing (hereinafter referred to as “visual field”), image-capturing of each visual field is sequentially performed by moving the stage 102 for each time of image-capturing. By tiling image data (hereinafter referred to as “visual field image data”) obtained by image-capturing of each visual field, wide visual field image data of the entire image-capturing region is generated. The generated wide visual field image data is stored in, for example, the fluorescence signal storage unit 122 (see FIG. 1). Note that tiling of the visual field image data may be executed in the acquisition unit 110 of the information processing apparatus 100, may be executed in the storage unit 120, or may be executed in the processing unit 130.

Then, the processing unit 130 can execute a series of processing including positive threshold value acquisition processing on the obtained wide visual field image data.

### (Method for Calculating Number of Fluorescent Molecules or Number of Antibodies)

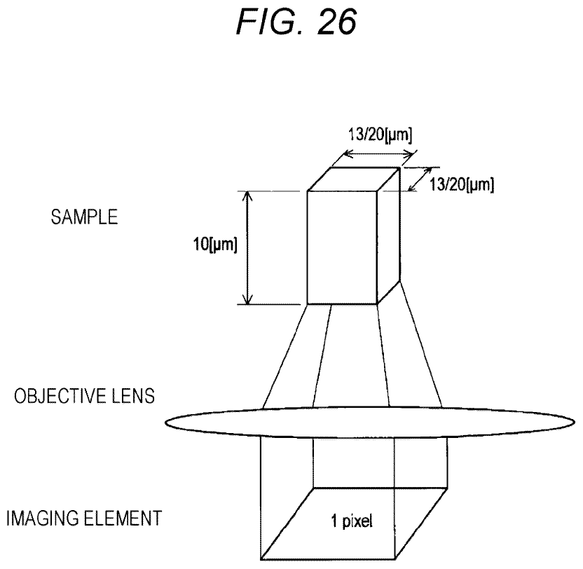

Next, a method for calculating the number of fluorescent molecules or the number of antibodies in one pixel will be described. FIG. 26 is a schematic view for explaining a method for calculating the number of fluorescent molecules or the number of antibodies in one pixel. In the example illustrated in FIG. 26, in a case where an imaging element and a sample are disposed via an objective lens, a size of a bottom surface of the sample corresponding to 1 [pixel] of the imaging element is assumed to be 13/20 (μm)×13/20 (μm). Then, a thickness of the sample is assumed to be 10 (μm). In that case, a volume of a cuboid of this sample is represented by 13/20 (μm)×13/20 (μm)×10 (μm). Note that a volume (liter) of this sample is represented by 13/20 (μm)×13/20 (μm)×10 (μm)×103.

Then, assuming that concentration of the number of antibodies (which may be the number of fluorescent molecules) contained in the sample is uniform and is 300 (nM), the number of antibodies per pixel is represented by the following Formula (24).

$$\\ \begin{matrix}[ Expression 11 ] & \\ 300 * {10}^{{}_{} - 9} * ( \frac{13}{20} * \frac{13}{20} * 10 * {( {10}^{{}_{} - 6} )}^{3} ) * {10}^{{}_{} 3} * 6.02 * {10}^{{}_{} 23} & ( 11 )\end{matrix}$$

As described above, the number of fluorescent molecules or the number of antibodies in the fluorescent-stained specimen 30 is calculated as a result of the fluorescence separation processing, so that the implementer can compare the number of fluorescent molecules among a plurality of fluorescent substances or compare data that is imaged under different conditions. Furthermore, since the number of fluorescent molecules or the number of antibodies is a discrete value while a luminance (or fluorescence intensity) is a continuous value, the information processing apparatus 100 can reduce a data amount by outputting image information on the basis of the number of fluorescent molecules or the number of antibodies.

### Hardware Configuration Example

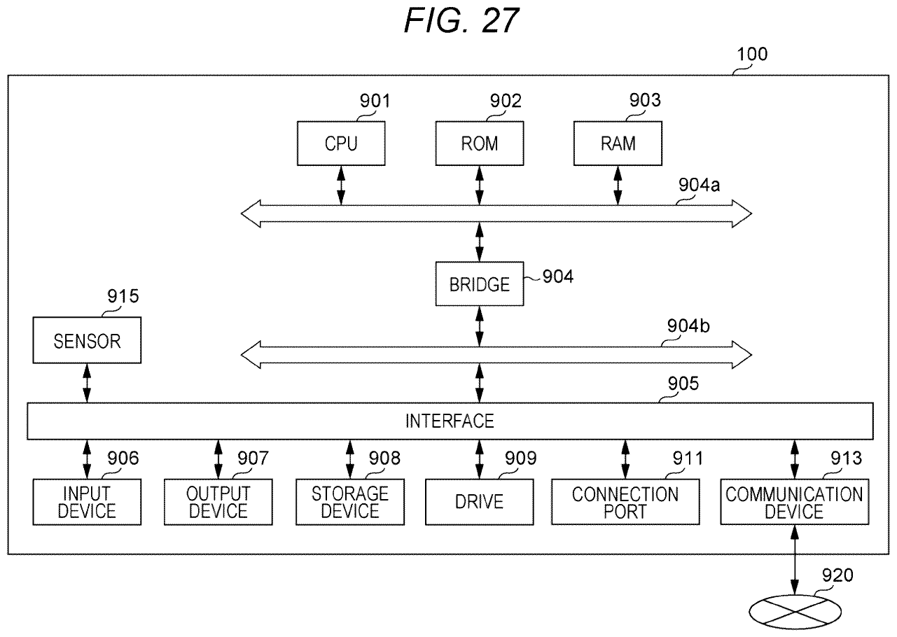

With reference to FIG. 27, a hardware configuration example of the information processing apparatus 100 will be described. FIG. 27 is a block diagram illustrating a hardware configuration example of the information processing apparatus 100. Various types of processing by the information processing apparatus 100 are implemented by cooperation of software and hardware described below.

As illustrated in FIG. 27, the information processing apparatus 100 includes a central processing unit (CPU) 901, a read only memory (ROM) 902, a random access memory (RAM) 903, and a host bus 904a. Furthermore, the information processing apparatus 100 includes a bridge 904, an external bus 904b, an interface 905, an input device 906, an output device 907, a storage device 908, a drive 909, a connection port 911, a communication device 913, and a sensor 915. The information processing apparatus 100 may include a processing circuit such as a DSP or an ASIC, instead of or in addition to the CPU 901.

The CPU 901 functions as an arithmetic processing device and a control device, and controls the overall operation in the information processing apparatus 100 in accordance with various programs. Furthermore, the CPU 901 may also be a microprocessor. The ROM 902 stores a program, operation parameters, and the like used by the CPU 901. The RAM 903 temporarily stores a program used in execution of the CPU 901, parameters that appropriately change in the execution thereof, and the like. The CPU 901 can embody, for example, at least the processing unit 130 and the control unit 150 of the information processing apparatus 100.

The CPU 901, the ROM 902, and the RAM 903 are mutually connected by the host bus 904a including a CPU bus and the like. The host bus 904a is connected to the external bus 904b such as a peripheral component interconnect/interface (PCI) bus via the bridge 904. Note that the host bus 904a, the bridge 904, and the external bus 904b do not necessarily have a configuration separated from each other, and may be implemented in a single configuration (for example, one bus).

The input device 906 is implemented by, for example, a device to which information is input by the implementer, such as a mouse, a keyboard, a touch panel, a button, a microphone, a switch, and a lever. Furthermore, the input device 906 may be, for example, a remote control device using infrared rays or other radio waves, or may be an external connection device such as a mobile phone or a PDA corresponding to an operation of the information processing apparatus 100. Moreover, the input device 906 may include, for example, an input control circuit that generates an input signal on the basis of information input by the implementer by using the input means described above and outputs the input signal to the CPU 901. By operating the input device 906, the implementer can input various types of data and give an instruction to perform a processing operation, to the information processing apparatus 100. The input device 906 can embody at least the operation unit 160 of the information processing apparatus 100, for example.

The output device 907 includes a device capable of visually or audibly notifying the implementer of acquired information. Examples of such a device include a display device such as a CRT display device, a liquid crystal display device, a plasma display device, an EL display device, and a lamp, a sound output device such as a speaker and a headphone, a printer device, and the like. The output device 907 can embody at least the display unit 140 of the information processing apparatus 100, for example.

The storage device 908 is a device for data storage. The storage device 908 is implemented by, for example, a magnetic storage device such as an HDD, a semiconductor storage device, an optical storage device, a magneto-optical storage device, or the like. The storage device 908 may include a storage medium, a recording device that records data on the storage medium, a reading device that reads data from the storage medium, a deletion device that deletes data recorded on the storage medium, or the like. The storage device 908 stores programs and various types of data executed by the CPU 901, and various types of data acquired from the outside, and the like. The storage device 908 can embody at least the storage unit 120 of the information processing apparatus 100, for example.

The drive 909 is a reader/writer for a storage medium, and is built in or externally attached to the information processing apparatus 100. The drive 909 reads information recorded on a removable storage medium such as a mounted magnetic disk, optical disk, magneto-optical disk, or semiconductor memory, and outputs the information to the RAM 903. Furthermore, the drive 909 can also write information to the removable storage medium.

The connection port 911 is an interface to be connected with an external device, and is a connection port between with an external device capable of transmitting data by, for example, a universal serial bus (USB) or the like.

The communication device 913 is, for example, a communication interface formed by a communication device or the like for connecting to a network 920. The communication device 913 is, for example, a communication card or the like for wired or wireless local area network (LAN), long term evolution (LTE), Bluetooth (registered trademark), or wireless USB (WUSB). Furthermore, the communication device 913 may be a router for optical communication, a router for asymmetric digital subscriber line (ADSL), a modem for various communications, or the like. The communication device 913 can transmit and receive, for example, signals and the like to and from the Internet and other communication devices in accordance with, for example, a predetermined protocol such as TCP/IP.

In the present embodiment, the sensor 915 includes a sensor capable of acquiring a spectrum (for example, an imaging element or the like), but may include other sensors (for example, an acceleration sensor, a gyro sensor, a geomagnetic sensor, a pressure-sensitive sensor, a sound sensor, a distance measuring sensor, and the like). The sensor 915 can embody at least the fluorescence signal acquisition unit 112 of the information processing apparatus 100, for example.

Note that the network 920 is a wired or wireless transmission path of information transmitted from a device connected to the network 920. For example, the network 920 may include a public network such as the Internet, a telephone network, or a satellite communication network, various local area networks (LANs) including Ethernet (registered trademark), a wide area network (WAN), and the like. Furthermore, the network 920 may include a dedicated line network such as an Internet protocol-virtual private network (IP-VPN).

A hardware configuration example capable of implementing the functions of the information processing apparatus 100 has been described above. Each of the above-described components may be implemented using a general-purpose member, or may be implemented by hardware specialized for the function of each component. Therefore, it is possible to appropriately change the hardware configuration to be used in accordance with a technical level at the time of carrying out the present disclosure.

Note that a computer program for realizing each function of the information processing apparatus 100 as described above can be created and mounted on a PC or the like. Furthermore, a computer-readable recording medium storing such a computer program can also be provided. The recording medium includes, for example, a magnetic disk, an optical disk, a magneto-optical disk, a flash memory, or the like. Furthermore, the computer program described above may be distributed via, for example, a network without using a recording medium.

It should be noted that the embodiment and modifications disclosed in the present specification are illustrative only in all respects and are not to be construed as limiting. The above-described embodiment and modifications can be omitted, replaced, and changed in various forms without departing from the scope and spirit of the appended claims. For example, the above-described embodiment and modifications may be combined in whole or in part, and other embodiments may be combined with the above-described embodiment or modifications. Furthermore, the effects of the present disclosure described in the present specification are merely exemplification, and other effects may be provided.

A technical category embodying the above technical idea is not limited. For example, the above-described technical idea may be embodied by a computer program for causing a computer to execute one or a plurality of procedures (steps) included in a method for manufacturing or using the above-described apparatus. Furthermore, the above-described technical idea may be embodied by a computer-readable non-transitory recording medium in which such a computer program is recorded.

The present disclosure can also have the following configurations.

### Item 1

An information processing apparatus including:
a first separation unit configured to separate a stained specimen fluorescence spectrum into a stained fluorescence component image containing a fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent;
a second separation unit configured to separate an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent;
a threshold value determination unit configured to determine a positive threshold value that is to be compared with image data of a plurality of image sections included in the stained fluorescence component image on the basis of the stained fluorescence component image, the positive threshold value being a criterion for determining whether or not each of the plurality of image sections corresponds to a positive cell image; and
a threshold value output unit configured to output the positive threshold value.

### Item 2

The information processing apparatus according to item 1, in which
the first separation unit:
generates a pseudo stained fluorescence spectrum on the basis of the stained fluorescence component image and the fluorescence reference spectrum;
generates a pseudo stained autofluorescence spectrum on the basis of the stained autofluorescence component image and the autofluorescence reference spectrum;
generates a pseudo stained specimen fluorescence spectrum on the basis of the pseudo stained fluorescence spectrum and the pseudo stained autofluorescence spectrum;
generates a difference stained specimen fluorescence spectrum on the basis of a difference between the stained specimen fluorescence spectrum and the pseudo stained specimen fluorescence spectrum; and
separates the difference stained specimen fluorescence spectrum into a difference stained fluorescence component image containing the fluorescent reagent and a difference stained autofluorescence component image containing the autofluorescence component by using the fluorescence reference spectrum and the autofluorescence reference spectrum,
the second separation unit:
generates a pseudo unstained fluorescence spectrum on the basis of the unstained fluorescence component image and the fluorescence reference spectrum;
generates a pseudo unstained autofluorescence spectrum on the basis of the unstained autofluorescence component image and the autofluorescence reference spectrum;
generates a pseudo unstained specimen fluorescence spectrum on the basis of the pseudo unstained fluorescence spectrum and the pseudo unstained autofluorescence spectrum;
generates a difference unstained specimen fluorescence spectrum on the basis of a difference between the unstained specimen fluorescence spectrum and the pseudo unstained specimen fluorescence spectrum; and
separates the difference unstained specimen fluorescence spectrum into a difference unstained fluorescence component image containing the fluorescent reagent and a difference unstained autofluorescence component image containing the autofluorescence component by using the fluorescence reference spectrum and the autofluorescence reference spectrum, and
the threshold value determination unit corrects the positive threshold value on the basis of a spectrum of the difference stained fluorescence component image and a spectrum of the difference unstained fluorescence component image.

### Item 3

The information processing apparatus according to item 1, in which
the first separation unit:
generates a pseudo stained fluorescence spectrum on the basis of the stained fluorescence component image and the fluorescence reference spectrum;
generates a pseudo stained autofluorescence spectrum on the basis of the stained autofluorescence component image and the autofluorescence reference spectrum;
generates a pseudo stained specimen fluorescence spectrum on the basis of the pseudo stained fluorescence spectrum and the pseudo stained autofluorescence spectrum; and
generates a difference stained specimen fluorescence spectrum on the basis of a difference between the stained specimen fluorescence spectrum and the pseudo stained specimen fluorescence spectrum, and
the second separation unit:
generates a pseudo unstained fluorescence spectrum on the basis of the unstained fluorescence component image and the fluorescence reference spectrum;
generates a pseudo unstained autofluorescence spectrum on the basis of the unstained autofluorescence component image and the autofluorescence reference spectrum;
generates a pseudo unstained specimen fluorescence spectrum on the basis of the pseudo unstained fluorescence spectrum and the pseudo unstained autofluorescence spectrum; and
generates a difference unstained specimen fluorescence spectrum on the basis of a difference between the unstained specimen fluorescence spectrum and the pseudo unstained specimen fluorescence spectrum, and
the threshold value determination unit corrects the positive threshold value on the basis of the difference stained specimen fluorescence spectrum and the difference unstained specimen fluorescence spectrum.

### Item 4

The information processing apparatus according to item 1, in which
the second separation unit:
generates a pseudo unstained fluorescence spectrum on the basis of the unstained fluorescence component image and the fluorescence reference spectrum;
generates a pseudo unstained autofluorescence spectrum on the basis of the unstained autofluorescence component image and the autofluorescence reference spectrum;
generates a pseudo unstained specimen fluorescence spectrum on the basis of the pseudo unstained fluorescence spectrum and the pseudo unstained autofluorescence spectrum;
generates a difference unstained specimen fluorescence spectrum on the basis of a difference between the unstained specimen fluorescence spectrum and the pseudo unstained specimen fluorescence spectrum; and
generates difference unstained norm data that is norm data of the difference unstained specimen fluorescence spectrum, and
the threshold value determination unit:
analyzes the difference unstained norm data to obtain outlier data;
corrects the unstained fluorescence component image on the basis of the outlier data; and
determines the positive threshold value on the basis of the corrected unstained fluorescence component image.

### Item 5

The information processing apparatus according to any one of items 1 to 4, in which
the threshold value determination unit corrects the positive threshold value on the basis of a correction value determined in advance in accordance with the fluorescent reagent.

### Item 6

The information processing apparatus according to item 5, in which
on the basis of reagent identification information associated with the fluorescent reagent, the threshold value determination unit acquires the correction value from a correction data storage unit that stores the reagent identification information and the correction value in association with each other.

### Item 7

The information processing apparatus according to any one of items 1 to 3, in which
the threshold value determination unit corrects the positive threshold value, on the basis of a correction value determined in advance in accordance with a combination of the fluorescent reagent and a labeling target to be labeled with the fluorescent reagent.

### Item 8

The information processing apparatus according to item 7, in which
on the basis of labeling target identification information associated with the specimen and reagent identification information associated with the fluorescent reagent, the threshold value determination unit acquires the correction value from a correction data storage unit that stores the labeling target identification information, the reagent identification information, and the correction value in association with each other.

### Item 9

The information processing apparatus according to any one of items 1 to 8, in which
the threshold value determination unit determines the positive threshold value for each of a plurality of observation regions defined by sectioning the stained fluorescence component image.

### Item 10

The information processing apparatus according to item 9, in which
the threshold value determination unit determines the positive threshold value for each of the plurality of observation regions defined by a user.

### Item 11

The information processing apparatus according to item 9, in which the threshold value determination unit specifies a noise component included in the stained specimen fluorescence spectrum, and defines the plurality of observation regions by sectioning the stained fluorescence component image in accordance with the noise component.

### Item 12

The information processing apparatus according to any one of items 1 to 11, in which
the threshold value determination unit determines a correctable range of the positive threshold value, and
the threshold value output unit outputs the positive threshold value and information indicating the correctable range.

### Item 13

A microscope system including:
a light irradiation unit configured to emit excitation light that excites a fluorescent reagent;
an imaging device configured to image a specimen being irradiated with the excitation light, to acquire a specimen fluorescence spectrum; and
an information processing apparatus configured to analyze the specimen fluorescence spectrum, in which
the information processing apparatus includes:
a first separation unit configured to separate a stained specimen fluorescence spectrum into a stained fluorescence component image containing the fluorescent reagent and a stained autofluorescence component image containing an autofluorescence component by using a fluorescence reference spectrum and an autofluorescence reference spectrum, the stained specimen fluorescence spectrum being acquired by irradiating, with the excitation light, a fluorescent-stained specimen obtained by labeling a specimen with the fluorescent reagent;
a second separation unit configured to separate an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent; and
a threshold value determination unit configured to determine a positive threshold value that is to be compared with image data of a plurality of image sections included in the stained fluorescence component image on the basis of the stained fluorescence component image, the positive threshold value being a criterion for determining whether or not each of the plurality of image sections corresponds to a positive cell image.

### Item 14

The microscope system of item 13, further including:
a presentation information generation unit configured to generate presentation information that is displayed on a display unit and includes threshold value information indicating the positive threshold value.

### Item 15

The microscope system of item 14, in which
the threshold value determination unit determines a correctable range of the positive threshold value, and
the presentation information includes correctable range information indicating the correctable range.

### Item 16

The microscope system of any of items 13 to 15, further including:
an analysis unit configured to perform analysis on the basis of the positive threshold value.

### Item 17

An information processing method including:
a process of separating a stained specimen fluorescence spectrum into a stained fluorescence component image containing a fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent;
a process of separating an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent;
a process of determining a positive threshold value that is to be compared with image data of a plurality of image sections included in the stained fluorescence component image on the basis of the stained fluorescence component image, the positive threshold value being a criterion for determining whether or not each of the plurality of image sections corresponds to a positive cell image; and
a process of outputting the positive threshold value.

### Item 18

An information processing apparatus including:
a first separation unit configured to separate a stained specimen fluorescence spectrum into a stained fluorescence component image containing a fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent;
a threshold value determination unit configured to determine a positive threshold value that is to be compared with image data of a plurality of image sections included in the stained fluorescence component image, the positive threshold value being a criterion for determining whether or not each of the plurality of image sections corresponds to a positive cell image, on the basis of image spectrum data derived on the basis of the stained fluorescence component image and the fluorescence reference spectrum; and
a threshold value output unit configured to output the positive threshold value.

### Item 19

The information processing apparatus according to item 18, in which
the first separation unit:
generates a pseudo stained fluorescent reagent spectrum on the basis of the stained fluorescence component image and the fluorescence reference spectrum;
generates a pseudo stained autofluorescence component spectrum on the basis of the stained autofluorescence component image and the autofluorescence reference spectrum;
generates a pseudo stained specimen fluorescence spectrum on the basis of the pseudo stained fluorescent reagent spectrum and the pseudo stained autofluorescence component spectrum;
generates a difference stained specimen fluorescence spectrum on the basis of a difference between the stained specimen fluorescence spectrum and the pseudo stained specimen fluorescence spectrum; and
separates the difference stained specimen fluorescence spectrum into a difference stained fluorescence component image containing the fluorescent reagent and a difference stained autofluorescence component image containing the autofluorescence component by using the fluorescence reference spectrum and the autofluorescence reference spectrum, and
the threshold value determination unit determines the positive threshold value on the basis of the difference stained fluorescence component image.

### Item 20

The information processing apparatus according to item 18 or 19, in which
the threshold value determination unit corrects the positive threshold value on the basis of a correction value determined in advance in accordance with the fluorescent reagent.

### Item 21

The information processing apparatus according to item 20, in which
on the basis of reagent identification information associated with the fluorescent reagent, the threshold value determination unit acquires the correction value from a correction data storage unit that stores the reagent identification information and the correction value in association with each other.

### Item 22

The information processing apparatus according to any one of items 18 to 21, in which
the threshold value determination unit corrects the positive threshold value, on the basis of a correction value determined in advance in accordance with a combination of the fluorescent reagent and a labeling target to be labeled with the fluorescent reagent.

### Item 23

The information processing apparatus according to item 22, in which
on the basis of labeling target identification information associated with the specimen and reagent identification information associated with the fluorescent reagent, the threshold value determination unit acquires the correction value from a correction data storage unit that stores the labeling target identification information, the reagent identification information, and the correction value in association with each other.

### Item 24

The information processing apparatus according to any one of items 18 to 23, in which
the threshold value determination unit determines the positive threshold value for each of a plurality of observation regions defined by sectioning the stained fluorescence component image.

### Item 25

The information processing apparatus according to item 24, in which
the threshold value determination unit determines the positive threshold value for each of the plurality of observation regions defined by a user.

### Item 26

The information processing apparatus according to item 24, in which the threshold value determination unit specifies a noise component included in the stained specimen fluorescence spectrum, and defines the plurality of observation regions by sectioning the stained fluorescence component image in accordance with the noise component.

### Item 27

The information processing apparatus according to any one of items 18 to 26, in which
the threshold value determination unit determines a correctable range of the positive threshold value, and
the threshold value output unit outputs the positive threshold value and information indicating the correctable range.

### Item 28

A microscope system including:
a light irradiation unit configured to emit excitation light that excites a fluorescent reagent;
an imaging device configured to image a specimen being irradiated with the excitation light, to acquire a specimen fluorescence spectrum; and
an information processing apparatus configured to analyze the specimen fluorescence spectrum, in which
the information processing apparatus includes:
a first separation unit configured to separate a stained specimen fluorescence spectrum into a stained fluorescence component image containing the fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent;
a threshold value determination unit configured to determine a positive threshold value that is to be compared with image data of a plurality of image sections included in the stained fluorescence component image, the positive threshold value being a criterion for determining whether or not each of the plurality of image sections corresponds to a positive cell image, on the basis of image spectrum data derived on the basis of the stained fluorescence component image and the fluorescence reference spectrum; and
a threshold value output unit configured to output the positive threshold value.

### Item 29

The microscope system of item 28, further including:
a presentation information generation unit configured to generate presentation information that is displayed on a display unit and includes threshold value information indicating the positive threshold value.

### Item 30

The microscope system of item 29, in which
the threshold value determination unit determines a correctable range of the positive threshold value, and
the presentation information includes correctable range information indicating the correctable range.

### Item 31

The microscope system of any of items 28 to 30, further including:
an analysis unit configured to perform analysis on the basis of the positive threshold value.

### Item 32

An information processing method including:
a process of separating a stained specimen fluorescence spectrum into a stained fluorescence component image containing a fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent;
a process of determining a positive threshold value that is to be compared with image data of a plurality of image sections included in the stained fluorescence component image, the positive threshold value being a criterion for determining whether or not each of the plurality of image sections corresponds to a positive cell image, on the basis of image spectrum data derived on the basis of the stained fluorescence component image and the fluorescence reference spectrum; and
a process of outputting the positive threshold value.

### REFERENCE SIGNS LIST

10 Fluorescent reagent
11 Reagent identification information
20 Specimen
21 Specimen identification information
30 Fluorescent-stained specimen
40 Separation unit
41 First separation unit
42 Second separation unit
43 Threshold value determination unit
44 Separation output unit
45 Image spectrum output unit
46 Threshold value output unit
47 Analysis unit
100 Information processing apparatus
101 Microscope
102 Stage
103 Optical system
103A Objective lens
103B Imaging lens
103C Dichroic mirror
103D Emission filter
103E Excitation filter
104 Light source
105 Stage drive unit
106 Light source drive unit
107 Data processing unit
110 Acquisition unit
111 Information acquisition unit
112 Fluorescence signal acquisition unit
120 Storage unit
Lu Correctable upper limit value
Ld Correctable lower limit value
121 Information storage unit
122 Fluorescence signal storage unit
130 Processing unit
131 Joining unit
Q Positive threshold mark
132 Separation processing unit
133 Image generation unit
140 Display unit
150 Control unit
160 Operation unit
200 Database
D1 Stained specimen fluorescence spectrum
D2 Stained fluorescence component image
D3 Stained autofluorescence component image
D4 Pseudo stained fluorescence spectrum
D5 Pseudo stained autofluorescence spectrum
D6 Stained specific channel luminance image
D7 Pseudo stained specimen fluorescence spectrum
D8 Difference stained specimen fluorescence spectrum
D9 Difference stained norm image
D10 Difference stained fluorescence component image
Dl1 Difference stained autofluorescence component image
D21 Unstained specimen fluorescence spectrum
D22 Unstained fluorescence component image
D23 Unstained autofluorescence component image
D24 Pseudo unstained fluorescence spectrum
D25 Pseudo unstained autofluorescence spectrum
D26 Unstained specific channel luminance image
D27 Pseudo unstained specimen fluorescence spectrum
D28 Difference unstained specimen fluorescence spectrum
D29 Difference unstained norm image
D30 Difference unstained fluorescence component image
D31 Difference unstained autofluorescence component image
J1 Specimen image information
J2 Presentation information
K1 Non-positive cell image
K2 Positive cell image
Ld Correctable lower limit value
Lu Correctable upper limit value
M1 Cell image position emphasis mark
M2 Observation region emphasis mark
Q Positive threshold mark
Q1 First positive threshold mark
Q2 Second positive threshold mark
R1 Fluorescence reference spectrum
R2 Autofluorescence reference spectrum
Rs1 First observation region
Rs2 Second observation region
Tm Mask threshold value

1. An information processing apparatus comprising:
a first separation unit configured to separate a stained specimen fluorescence spectrum into a stained fluorescence component image containing a fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent;
a second separation unit configured to separate an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent;
a threshold value determination unit configured to determine a positive threshold value that is to be compared with image data of a plurality of image sections included in the stained fluorescence component image on a basis of the stained fluorescence component image, the positive threshold value being a criterion for determining whether or not each of the plurality of image sections corresponds to a positive cell image; and
a threshold value output unit configured to output the positive threshold value.

2. The information processing apparatus according to claim 1, wherein
the first separation unit:
generates a pseudo stained fluorescence spectrum on a basis of the stained fluorescence component image and the fluorescence reference spectrum;
generates a pseudo stained autofluorescence spectrum on a basis of the stained autofluorescence component image and the autofluorescence reference spectrum;
generates a pseudo stained specimen fluorescence spectrum on a basis of the pseudo stained fluorescence spectrum and the pseudo stained autofluorescence spectrum;
generates a difference stained specimen fluorescence spectrum on a basis of a difference between the stained specimen fluorescence spectrum and the pseudo stained specimen fluorescence spectrum; and
separates the difference stained specimen fluorescence spectrum into a difference stained fluorescence component image containing the fluorescent reagent and a difference stained autofluorescence component image containing the autofluorescence component by using the fluorescence reference spectrum and the autofluorescence reference spectrum,
the second separation unit:
generates a pseudo unstained fluorescence spectrum on a basis of the unstained fluorescence component image and the fluorescence reference spectrum;
generates a pseudo unstained autofluorescence spectrum on a basis of the unstained autofluorescence component image and the autofluorescence reference spectrum;
generates a pseudo unstained specimen fluorescence spectrum on a basis of the pseudo unstained fluorescence spectrum and the pseudo unstained autofluorescence spectrum;
generates a difference unstained specimen fluorescence spectrum on a basis of a difference between the unstained specimen fluorescence spectrum and the pseudo unstained specimen fluorescence spectrum; and
separates the difference unstained specimen fluorescence spectrum into a difference unstained fluorescence component image containing the fluorescent reagent and a difference unstained autofluorescence component image containing the autofluorescence component by using the fluorescence reference spectrum and the autofluorescence reference spectrum, and
the threshold value determination unit corrects the positive threshold value on a basis of a spectrum of the difference stained fluorescence component image and a spectrum of the difference unstained fluorescence component image.

3. The information processing apparatus according to claim 1, wherein
the first separation unit:
generates a pseudo stained fluorescence spectrum on a basis of the stained fluorescence component image and the fluorescence reference spectrum;
generates a pseudo stained autofluorescence spectrum on a basis of the stained autofluorescence component image and the autofluorescence reference spectrum;
generates a pseudo stained specimen fluorescence spectrum on a basis of the pseudo stained fluorescence spectrum and the pseudo stained autofluorescence spectrum; and
generates a difference stained specimen fluorescence spectrum on a basis of a difference between the stained specimen fluorescence spectrum and the pseudo stained specimen fluorescence spectrum,
the second separation unit,
generates a pseudo unstained fluorescence spectrum on a basis of the unstained fluorescence component image and the fluorescence reference spectrum;
generates a pseudo unstained autofluorescence spectrum on a basis of the unstained autofluorescence component image and the autofluorescence reference spectrum;
generates a pseudo unstained specimen fluorescence spectrum on a basis of the pseudo unstained fluorescence spectrum and the pseudo unstained autofluorescence spectrum; and
generates a difference unstained specimen fluorescence spectrum on a basis of a difference between the unstained specimen fluorescence spectrum and the pseudo unstained specimen fluorescence spectrum, and
the threshold value determination unit corrects the positive threshold value on a basis of the difference stained specimen fluorescence spectrum and the difference unstained specimen fluorescence spectrum.

4. The information processing apparatus according to claim 1, wherein
the second separation unit:
generates a pseudo unstained fluorescence spectrum on a basis of the unstained fluorescence component image and the fluorescence reference spectrum;
generates a pseudo unstained autofluorescence spectrum on a basis of the unstained autofluorescence component image and the autofluorescence reference spectrum;
generates a pseudo unstained specimen fluorescence spectrum on a basis of the pseudo unstained fluorescence spectrum and the pseudo unstained autofluorescence spectrum;
generates a difference unstained specimen fluorescence spectrum on a basis of a difference between the unstained specimen fluorescence spectrum and the pseudo unstained specimen fluorescence spectrum; and
generates difference unstained norm data that is norm data of the difference unstained specimen fluorescence spectrum, and
the threshold value determination unit:
analyzes the difference unstained norm data to obtain outlier data;
corrects the unstained fluorescence component image on a basis of the outlier data; and
determines the positive threshold value on a basis of the corrected unstained fluorescence component image.

5. The information processing apparatus according to claim 1, wherein
the threshold value determination unit corrects the positive threshold value on a basis of a correction value determined in advance in accordance with the fluorescent reagent.

6. The information processing apparatus according to claim 5, wherein
on a basis of reagent identification information associated with the fluorescent reagent, the threshold value determination unit acquires the correction value from a correction data storage unit that stores the reagent identification information and the correction value in association with each other.

7. The information processing apparatus according to claim 1, wherein
the threshold value determination unit corrects the positive threshold value, on a basis of a correction value determined in advance in accordance with a combination of the fluorescent reagent and a labeling target to be labeled with the fluorescent reagent.

8. The information processing apparatus according to claim 7, wherein
on a basis of labeling target identification information associated with the specimen and reagent identification information associated with the fluorescent reagent, the threshold value determination unit acquires the correction value from a correction data storage unit that stores the labeling target identification information, the reagent identification information, and the correction value in association with each other.

9. The information processing apparatus according to claim 1, wherein
the threshold value determination unit determines the positive threshold value for each of a plurality of observation regions defined by sectioning the stained fluorescence component image.

10. The information processing apparatus according to claim 9, wherein
the threshold value determination unit determines the positive threshold value for each of the plurality of observation regions defined by a user.

11. The information processing apparatus according to claim 9, wherein the threshold value determination unit specifies a noise component included in the stained specimen fluorescence spectrum, and defines the plurality of observation regions by sectioning the stained fluorescence component image in accordance with the noise component.

12. The information processing apparatus according to claim 1, wherein
the threshold value determination unit determines a correctable range of the positive threshold value, and
the threshold value output unit outputs the positive threshold value and information indicating the correctable range.

13. A microscope system comprising:
a light irradiation unit configured to emit excitation light that excites a fluorescent reagent;
an imaging device configured to image a specimen being irradiated with the excitation light, to acquire a specimen fluorescence spectrum; and
an information processing apparatus configured to analyze the specimen fluorescence spectrum, wherein
the information processing apparatus includes:
a first separation unit configured to separate a stained specimen fluorescence spectrum into a stained fluorescence component image containing the fluorescent reagent and a stained autofluorescence component image containing an autofluorescence component by using a fluorescence reference spectrum and an autofluorescence reference spectrum, the stained specimen fluorescence spectrum being acquired by irradiating, with the excitation light, a fluorescent-stained specimen obtained by labeling a specimen with the fluorescent reagent;
a second separation unit configured to separate an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent; and
a threshold value determination unit configured to determine a positive threshold value that is to be compared with image data of a plurality of image sections included in the stained fluorescence component image on a basis of the stained fluorescence component image, the positive threshold value being a criterion for determining whether or not each of the plurality of image sections corresponds to a positive cell image.

14. The microscope system of claim 13, further comprising:
a presentation information generation unit configured to generate presentation information that is displayed on a display unit and includes threshold value information indicating the positive threshold value.

15. The microscope system according to claim 14, wherein
the threshold value determination unit determines a correctable range of the positive threshold value, and
the presentation information includes correctable range information indicating the correctable range.

16. The microscope system according to claim 13, further comprising:
an analysis unit configured to perform analysis on a basis of the positive threshold value.

17. An information processing method comprising:
a process of separating a stained specimen fluorescence spectrum into a stained fluorescence component image containing a fluorescent reagent and a stained autofluorescence component image containing an autofluorescence component by using a fluorescence reference spectrum and an autofluorescence reference spectrum, the stained specimen fluorescence spectrum being acquired by irradiating, with excitation light, a fluorescent-stained specimen obtained by labeling a specimen with the fluorescent reagent;
a process of separating an unstained specimen fluorescence spectrum into an unstained fluorescence component image containing the fluorescent reagent and an unstained autofluorescence component image containing the autofluorescence component by using the fluorescence reference spectrum and the autofluorescence reference spectrum, the unstained specimen fluorescence spectrum being acquired by irradiating, with the excitation light, a fluorescent-unstained specimen that is not labeled with the fluorescent reagent;
a process of determining a positive threshold value that is to be compared with image data of a plurality of image sections included in the stained fluorescence component image on a basis of the stained fluorescence component image, the positive threshold value being a criterion for determining whether or not each of the plurality of image sections corresponds to a positive cell image; and
a process of outputting the positive threshold value.
